(19) United States
(12) Patent Application Publication
(10) Pub. No.: US 2026/0112691 A1
(43) Pub. Date: Apr. 23, 2026

(54) METHOD FOR PRODUCING SOLID ELECTROLYTE, SOLID ELECTROLYTE, POSITIVE ELECTRODE MATERIAL, AND BATTERY

(71) Applicant: Panasonic Intellectual Property Management Co., Ltd., Osaka (JP)

(72) Inventor: Eiichi KOGA, Hokkaido (JP)

(21) Appl. No.: 19/425,409

(22) Filed: Dec. 18, 2025

Related U.S. Application Data
(63) Continuation of application No. PCT/JP2024/020793, filed on Jun. 6, 2024.

(30) Foreign Application Priority Data
Jun. 29, 2023 (JP) 2023-107590

(51) Int. Cl. H01M 10/0562; H01M 10/052

(52) U.S. Cl. CPC H01M 10/0562; H01M 10/052; H01M 2300/008

(57) ABSTRACT

A production method for a solid electrolyte of the present disclosure includes (A) performing fluorination treatment on a raw material including a composite oxide containing Li and Ti, to obtain a solid electrolyte including a crystal phase represented by a composition formula (1): Li₂TiF₆. A solid electrolyte of the present disclosure includes a crystal phase represented by the composition formula (1): Li₂TiF₆ and is substantially free of TiF₄.

This application is a continuation of PCT/JP2024/020793 filed on Jun. 6, 2024, which claims foreign priority of Japanese Patent Application No. 2023-107590 filed on Jun. 29, 2023, the entire contents of both of which are incorporated herein by reference.

### BACKGROUND OF THE INVENTION

### 1. Field of the Invention

The present disclosure relates to a production method for a solid electrolyte, a solid electrolyte, a positive electrode material, and a battery.

### 2. Description of Related Art

WO 2020/136956 (hereinafter, Patent Literature 1) discloses a production method for a halide solid electrolyte such as a solid electrolyte represented by a composition of Li₃YBr₃Cl₃. In addition, Thermochimica Acta 265 (1995) 189-195 (hereinafter, Non Patent Literature 1) discloses a solid electrolyte represented by a composition of LiYF₄ and a production method therefor.

### SUMMARY OF THE INVENTION

The present disclosure aims to provide a novel production method that allows a halide solid electrolyte having a target composition to be stably synthesized.

A production method for a solid electrolyte of the present disclosure includes

(A) performing fluorination treatment on a raw material including a composite oxide containing Li and Ti, to obtain a solid electrolyte including a crystal phase represented by the following composition formula (1).

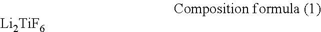

The present disclosure provides a novel production method that allows a halide solid electrolyte having a target composition to be stably synthesized.

### BRIEF DESCRIPTION OF THE DRAWINGS

FIG. 1 is a flowchart showing an example of a production method for a solid electrolyte according to a first embodiment.

FIG. 2 is a flowchart showing an example of a production method for a solid electrolyte according to a second embodiment.

FIG. 3 is a flowchart showing a modification of the production method for a solid electrolyte according to the second embodiment.

FIG. 4 is a flowchart showing an example of a production method for a solid electrolyte according to a third embodiment.

FIG. 5 illustrates a cross-sectional view of a battery 1000 according to a fourth embodiment.

FIG. 6 is a graph showing an X-ray diffraction pattern of a solid electrolyte after heat treatment (i.e., after fluorination) and before pulverization treatment ((a) after fluorination) in a production method of Example 1, an X-ray diffraction pattern of a solid electrolyte after the pulverization treatment obtained in Example 1 ((b) after pulverization), and an X-ray diffraction pattern of a solid electrolyte obtained in Comparative Example 1 ((c) Comparative Example 1).

### DETAILED DESCRIPTION

Hereinafter, embodiments of the present disclosure will be specifically described with reference to the drawings.

The embodiments described below are all comprehensive or specific examples. The numerical values, shapes, materials, components, etc., shown in the following embodiments are examples, and are not intended to limit the present disclosure. In addition, among the components in the following embodiments, the components that are not described in the independent claims that represent broadest concepts are described as discretionary components.

### First Embodiment

Hereinafter, a production method for a solid electrolyte according to a first embodiment will be described.

The production method according to the first embodiment includes

(A) performing fluorination treatment on a raw material including a composite oxide containing Li and Ti, to obtain a solid electrolyte including a crystal phase represented by the following composition formula (1).

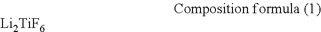

With the production method according to the first embodiment, a solid electrolyte having a target composition can be stably synthesized. Hereinafter, the reason for this will be described in more detail.

In the case where a solid electrolyte containing Ti is to be produced, a titanium fluoride (e.g., TiF₄) is normally used as a Ti source in a conventional production method. However, a titanium fluoride is a relatively unstable substance that easily evaporates and also has deliquescence properties, etc. Therefore, the produced solid electrolyte may cause compositional variations (i.e., compositional deviation) and alterations (e.g., incorporation of moisture, etc.). Accordingly, in the conventional production method, it may be difficult to stably obtain a target solid electrolyte. In contrast, in the production method according to the first embodiment, the composite oxide containing Li and Ti can be used as a Ti source. Therefore, in the production method according to the first embodiment, a solid electrolyte including a crystal phase represented by the composition formula (1): Li₂TiF₆ can be synthesized without using the above unstable and expensive titanium fluoride as a raw material. Thus, the production method according to the first embodiment is less likely to cause compositional variations, alterations, etc., to occur in the produced solid electrolyte and allows a solid electrolyte having a target composition to be synthesized stably with good reproducibility while further suppressing generation of a secondary phase. Moreover, with the production method according to the first embodiment, a fluoride can be generated at a lower temperature as compared to a conventional production method in which a solid-phase reaction of a fluoride raw material is caused, so that the raw material and the produced solid electrolyte are less likely to be exposed to high temperatures. Accordingly, the produced solid electrolyte does not become sintered and hard, and the particle growth of the solid electrolyte does not excessively proceed, so that a solid electrolyte that is soft and has excellent deformability is obtained as fine particles. When such a solid electrolyte having excellent deformability as fine particles is made into a compacted powder, an interface where particles are in close contact with each other is easily formed, the solid electrolyte can be highly densified and is easily thinned, and further improvement of the ionic conductivity thereof can also be expected. The hardness of the obtained solid electrolyte can be compared and evaluated, for example, by a method such as Micro-Vickers measurement for particles or a compacted powder.

For example, when Li₂TiF₆ synthesized by the production method according to the first embodiment is made into a compacted powder at a certain pressure, the density of the compacted powder can be shown to be 2.15 g/cm³ or more and 2.18 g/cm³ or less, as an example. This is larger than a density of 2.04 g/cm³ or more and 2.13 g/cm³ or less of a compacted powder that can be realized by making Li₂TiF₆, which is obtained by solid-phase synthesis from a fluoride using the fluoride as a raw material, into a compacted powder at the same pressure.

Therefore, according to the production method according to the first embodiment, a useful solid electrolyte that, when used, for example, for a solid electrolyte layer of a battery, can achieve thinning of the solid electrolyte layer or can be suitably used for a coating layer for active material particles, is obtained. Therefore, with the solid electrolyte produced by the production method according to the first embodiment, a battery having high performance is realized.

In the above (A), the fluorination treatment on the raw material may be performed, for example, by performing heat treatment on a fluorine-containing substance having thermal decomposition properties.

By performing the fluorination treatment on the raw material composite oxide containing Li and Ti through the heat treatment on the fluorine-containing substance having thermal decomposition properties, fluorination of the raw material and a solid-phase reaction for synthesizing a solid electrolyte can be caused to occur simultaneously. Therefore, a homogeneous solid electrolyte having excellent characteristics can be obtained in a short time while reducing reaction residues such as oxides. Moreover, since the fluorination treatment is performed by performing heat treatment on the fluorine-containing substance having thermal decomposition properties, the reactivity (fluorination properties) of the composite oxide included in the raw material is good, and the productivity is also excellent. Furthermore, for example, the temperatures of the fluorination reaction and the solid-phase reaction of the raw material and the progress of these reactions can also be controlled according to the thermal decomposition temperature of the fluorine-containing substance to be selected. Thus, the desired solid electrolyte can be obtained.

When a fluorine-containing substance having thermal decomposition properties is used for the fluorination treatment on the raw material, in the production method according to the first embodiment, the above (A) may include
(A-1) mixing the raw material and the fluorine-containing substance, and
(A-2) fluorinating the raw material by performing heat treatment on a mixture including the raw material and the fluorine-containing substance obtained in the above (A-1), to obtain the solid electrolyte.

In the production method according to the first embodiment, by performing the above (A-1) and the above (A-2), the heat treatment for the fluorination treatment can be performed on a homogeneous mixture obtained by mixing the raw material and the fluorine-containing substance. In addition, the contact area between the raw material and the fluorine-containing substance can be increased. Accordingly, the fluorination of the raw material is uniformly promoted, and thus a homogeneous solid electrolyte having excellent characteristics can be obtained.

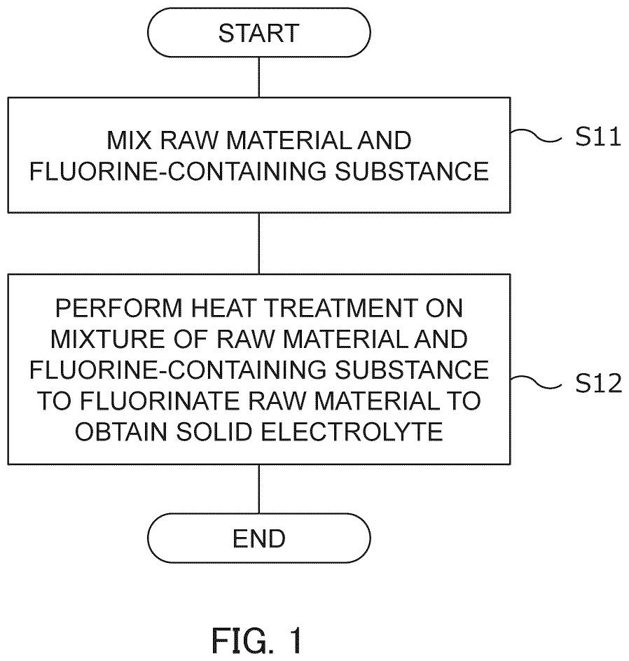

FIG. 1 is a flowchart showing an example of the production method for a solid electrolyte according to the first embodiment. Here, an example of a production method in which the above (A-1) and the above (A-2) are performed will be described as an example of the production method according to the first embodiment.

As shown in FIG. 1, in an example of the production method according to the first embodiment, first, as a step corresponding to the above (A-1), a raw material and a fluorine-containing substance are mixed (S11). As described above, the raw material includes a composite oxide containing Li and Ti. The fluorine-containing substance has thermal decomposition properties. Next, as a step corresponding to the above (A-2), the raw material is fluorinated by performing heat treatment on the obtained mixture including the raw material and the fluorine-containing substance (S12). Accordingly, a solid electrolyte including a crystal phase represented by the composition formula (1): Li₂TiF₆ is obtained.

Hereinafter, the raw material, the fluorine-containing substance, and the steps corresponding to the above (A-1) and the above (A-2), respectively, will be specifically described.

### <Raw Material>

The raw material includes a composite oxide containing Li and Ti.

By using the composite oxide containing Li and Ti as a Ti source, compositional variations and alterations of the produced solid electrolyte can be suppressed, and, for example, the desired solid electrolyte having high ionic conductivity and reliability can be produced. According to the production method of the first embodiment, it is not necessary to use a titanium oxide (e.g., TiO₂) as a Ti source. Regardless of crystal system (rutile, anatase), the titanium oxide is likely to generate a titanium fluoride (e.g., TiF₄), which is likely to cause problems of evaporation and deliquescence, in the process of fluorination. Therefore, the Ti component may disappear in the synthesis process or moisture may be contained due to the deliquescence of the titanium fluoride, which may lead to deviation from the desired composition. Therefore, the titanium fluoride may cause a decrease in the ionic conductivity and the reliability of the solid electrolyte. In the production method according to the first embodiment, since the composite oxide containing Li and Ti can be used as a Ti source, it is not necessary to use the titanium oxide. Therefore, it is possible to suppress compositional variations and alterations of the solid electrolyte caused by using the titanium oxide as described above, so that a solid electrolyte having high ionic conductivity can be stably produced.

For the above reasons, it is desirable that the raw material should be substantially free of TiO₂. Here, in this description, “the raw material is substantially free of TiO₂” means that the content ratio of TiO₂ in the entire raw material is 0.3 mass % or less.

The composite oxide containing Li and Ti is represented by the following composition formula (2), for example.

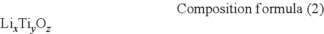

Here, in the above composition formula (2),

$$1.95 \leq x \leq 2.05 ,$$

$$0.95 \leq y \leq 1.05 , and$$

$$2.95 \leq z \leq 3.05$$

are satisfied.

The composite oxide represented by the above composition formula (2): LiₓTi_{y}O_{z} is an oxide that is stable in the atmospheric environment. Therefore, by using the composite oxide represented by the above composition formula (2): LiₓTi_{y}O_{z}, a solid electrolyte having good characteristics and including a crystal phase represented by the composition formula (1): Li₂TiF₆ can be synthesized stably in the atmospheric environment with good reproducibility.

The composite oxide containing Li and Ti may be Li₂TiO₃. By using Li₂TiO₃ as the composite oxide, a solid electrolyte having good characteristics and including a crystal phase represented by the composition formula (1): Li₂TiF₆ can be more efficiently produced stably in the atmospheric environment with good reproducibility.

The fluorination of the raw material progresses from the surface thereof, and thus the raw material may be, for example, in particle form. Accordingly, it becomes easier for fluorination (i.e., substitution of fluorine and oxygen elements) from the particle surface of the raw material and the solid-phase reaction in the raw material to occur simultaneously.

Thus, a homogeneous solid electrolyte having excellent characteristics can be obtained. In addition, the particulate raw material has good reactivity such as fluorination properties and solid-phase reactivity, and thus excellent productivity can also be achieved.

The above composite oxide included in the raw material may be in particle form, and the BET specific surface area of the composite oxide may be 1.0 m²/g or more and 30 m²/g or less. The composite oxide having such a BET specific surface area is suitable for fluorination treatment. Therefore, by using the composite oxide having such a configuration as the raw material, it becomes easier for fluorination (i.e., substitution of fluorine and oxygen elements) from the particle surface of the composite oxide and the solid-phase reaction to occur simultaneously. Therefore, for example, a fluoride having the composition formula (1): Li₂TiF₆ can be synthesized in a short time while reducing reaction residues such as oxides. As a result, a solid electrolyte including a crystal phase represented by the composition formula (1): Li₂TiF₆ can be synthesized in large quantities at a low cost.

In order to cause the fluorination treatment to more efficiently proceed to more efficiently produce a solid electrolyte, the BET specific surface area of the composite oxide may be 1.5 m²/g or more and 30 m²/g or less, may be 1.5 m²/g or more and 10 m²/g or less, or may be 1.0 m²/g or more and 10 m²/g or less. For example, in the case where the raw material is mixed by a wet method, if it is difficult to disperse the composite oxide since the BET specific surface area thereof is large, a dispersant may be used. In this case, a known dispersant that can be used in the production of solid electrolytes can be used as the dispersant.

The raw material may have an average particle diameter of 0.1 μm or more and 20 μm or less or may have an average particle diameter of 0.5 μm or more and 20 μm or less, for example. The average particle diameter of the composite oxide included in the raw material may be 0.1 μm or more and 20 μm or less, or may be 0.5 μm or more and 20 μm or less, for example. The raw material may be further micronized and may have, for example, an average particle diameter of 0.1 μm or more and 1.0 μm or less. The average particle diameter of the composite oxide included in the raw material may also be, for example, an average particle diameter of 0.1 μm or more and 1.0 μm or less. The average particle diameters of the raw material and the composite oxide are not limited to the above ranges, and any particle diameter and shape can be selected as appropriate from the viewpoint of fluorination and solid-phase reaction. For example, the smaller the particle diameters of the raw material and the composite oxide are, the lower the conversion temperature into the fluoride can be made.

The average particle diameters of the raw material and the composite oxide are each a median diameter and mean a particle diameter (d50) equivalent to 50% of the cumulative volume obtained from a particle size distribution measured on a volume basis by a laser diffraction scattering method. The same applies to the average particle diameter of the fluorine-containing substance specified in this specification.

The composite oxide can become a precursor of the crystal phase represented by the composition formula (1): Li₂TiF₆, which is included in the solid electrolyte to be produced by the production method according to the first embodiment, for example. For example, in order to obtain a single phase of Li_{z}TiF₆, it is desirable that the above composite oxide should be a single phase of LizTiO3, since the composite oxide can be converted into the fluoride without precipitating undesired phases. For example, if, in XRD measurement of the above composite oxide, the composite oxide can be confirmed to be a Li₂TiO₃ single phase, a single phase of Li_{z}TiF₆ can be obtained without generating TiF₄ by performing fluorination treatment on the composite oxide.

The above composite oxide used as the raw material may be synthesized in the production method according to the first embodiment.

For example, in the production method according to the first embodiment, the above (A) may include synthesizing the above composite oxide using at least one selected from the group consisting of an oxide of Li, a carbonate of Li, and a hydroxide of Li and at least one selected from the group consisting of an oxide of Ti, a carbonate of Ti, and a hydroxide of Ti. With this production method, the above composite oxide can be synthesized as the raw material using a Li source and a Ti source which have higher stability in atmospheric air and against moisture and lower cost compared with LiF and TiF₄. By performing fluorination treatment on the composite oxide thus synthesized, a crystal phase represented by the composition formula (1): Li₂TiF₆ can be produced with good reproducibility and high quality. Moreover, with this production method, for example, high-quality Li₂TiO₃ controlled to be a single phase can also be obtained with good reproducibility. Therefore, with this production method, a solid electrolyte having good characteristics can be synthesized stably in the atmospheric environment with good reproducibility.

Hereinafter, as for the raw material used for synthesizing the above composite oxide, at least one selected from the group consisting of an oxide of Li, a carbonate of Li, and a hydroxide of Li is referred to as Li raw material, and at least one selected from the group consisting of an oxide of Ti, a carbonate of Ti, and a hydroxide of Ti is referred to as Ti raw material.

The Li raw material and the Ti raw material used for synthesizing the above composite oxide are, for example, in particle form. The particle diameters and shapes of the Li raw material and the Ti raw material are arbitrary and are not particularly limited. In a general oxide synthesis process, in order to produce a composite oxide such as Li₂TiO₃, the average particle diameters of the Li raw material and the Ti raw material may be, for example, 0.1 μm or more and 20 μm or less, for ease of handling. The particles of the Li raw material and the Ti raw material may be spherical, elliptical, or aggregates of fine particles. The general oxide synthesis process means a normal production process of a ceramic material. The synthesis of the above composite oxide may be performed, for example, by a general solid-phase method.

The mixing of the raw material for synthesizing the above composite oxide may be dry mixing or wet mixing, and the mixing method may be any method as long as the raw material can be homogenized. In the wet mixing, a known general dispersant (ammonium polycarboxylate-based dispersants, non-ionic surfactants, etc.) may be used for mixing powders having a small particle diameter, uniform mixing, and increasing the treatment amount (i.e., increasing the solid content of a slurry). Accordingly, even with a fine powder (e.g., a powder having a BET specific surface area of about 30 m²/g), handling becomes easier, and uniform fluorination is enabled in the fluorination treatment in the subsequent step.

The above synthesized composite oxide may be subjected to, for example, pulverization treatment after solid-phase synthesis. By subjecting the composite oxide to the pulverization treatment, the particle diameter of the composite oxide can be decreased, or fracture surfaces of the particles broken by the pulverization treatment can be exposed. The fracture surfaces of the particles have higher activity than non-fractured surfaces thereof. Therefore, by such pulverization treatment, the reactivity of the composite oxide (i.e., reactivity for the solid-phase reaction and the fluorination reaction) can be increased. Therefore, by subjecting the above composite oxide to the pulverization treatment, the composite oxide can be made into a precursor raw material that is highly reactive, and as a result, the temperature for synthesizing the solid electrolyte can be lowered, and further, uniformity of the reaction can also be achieved. Therefore, the introduction of the pulverization treatment to the above composite oxide may be adjusted as appropriate from the viewpoint of the stability of synthesis and the characteristics of the above composite oxide. In addition, the above composite oxide may be a mixture of pulverized powder and non-pulverized powder. The fracture surface of the pulverized powder of the above composite oxide can be observed from a state different from the free surface, by scanning electron microscope (SEM) observation of the powder of the composite oxide. As the above composite oxide used as the raw material, an appropriate one can be used in view of the stability, characteristics, and handling in the production process of the composite oxide.

### <Fluorine-Containing Substance>

The fluorine-containing substance has thermal decomposition properties.

The thermal decomposition-starting temperature of the fluorine-containing substance to be used may be, for example, 100° C. or higher and 600° C. or lower. When the fluorine-containing substance has a thermal decomposition-starting temperature within the above temperature range, the fluorine-containing substance can have stability in storage and handling such as mixing, and the obtained solid electrolyte can be prevented from becoming excessively hard.

The fluorine-containing substance may be, for example, in particle form. Accordingly, the fluorine-containing substance easily becomes thermally decomposed. Therefore, by using the particulate fluorine-containing substance, the raw material can be efficiently fluorinated, and the fluorine-containing substance is less likely to remain in the finally obtained solid electrolyte. In addition, the fluorination reaction can be controlled by the particle shape of the fluorine-containing substance. For example, by making the particles of the fluorine-containing substance smaller, the temperature of the fluorination can be decreased, or the rate of the fluorination can be increased. In addition, by mixing the raw material and the fluorine-containing substance, uniform fluorination of the entire powder is enabled. Moreover, precise control of the fluorine amount is enabled. Thus, the synthesis of the desired solid electrolyte is enabled. In addition, the fluorine-containing substance can be used in an amount required for the fluorination of the raw material, so that, unlike the case where fluorine gas is introduced and used in a furnace, excess fluorine gas emission can be suppressed. Therefore, the environmental impact is reduced and the influence on corrosion of a furnace material, etc., is also reduced.

The fluorine-containing substance, for example, may have an average particle diameter of 0.5 μm or more and 500 μm or less, may have an average particle diameter of 0.5 μm or more and 150 μm or less, or may have an average particle diameter of 0.5 μm or more and 100 μm or less. As with the composite oxide, the fluorine-containing substance may also have any particle diameter and shape.

The average particle diameter of the fluorine-containing substance may be larger than the average particle diameter of the raw material. This results in a bulkier and fluffier state of a mixed powder of the raw material and the fluorine-containing substance. That is, this results in a state where the surface exposure area (i.e., exposure area) of the raw material is larger, and the contact points between the raw material particles are reduced. The fluorine in the fluorine-containing substance reacts with the particles of the raw material in a thermally-decomposed gas state. Thus, it becomes easier for fluorination to progress from the particle surface of the raw material, so that a homogeneous fluoride solid electrolyte can be obtained. Moreover, since the contact points between the particles of the raw material become discontinuous (i.e., the contact points between the particles of the raw material are reduced), after the fluorine-containing substance decomposes and disappears, the necking between the particles during the fluorination reaction and the solid-phase reaction is interrupted. Therefore, a solid electrolyte having fine particles can be synthesized. The average particle diameter of the fluorine-containing substance may be 5 μm or more and 150 μm or less, may be 5 μm or more and 100 μm or less, may be 5 μm or more and 20 μm or less, may be 50 μm or more and 100 μm or less, may be 50 μm or more and 120 μm or less, or may be 80 μm or more and 150 μm or less. The average particle diameter of the fluorine-containing substance can be adjusted as appropriate in consideration of the temperature or reactivity of fluorination. For example, by increasing the average particle diameter of the fluorine-containing substance, the heat treatment temperature for the fluorination treatment is increased.

The fluorine-containing substance may include ammonium fluoride (NH₄F). The thermal decomposition of ammonium fluoride starts at a relatively low temperature (e.g., about 150° C.). Therefore, ammonium fluoride is less likely to remain as an unnecessary inorganic component in the finally obtained solid electrolyte and can be thermally decomposed at a low temperature to fluorinate the raw material. Thus, by using ammonium fluoride as the fluorine-containing substance, unnecessary inorganic components derived from the fluorine-containing substance can be inhibited from remaining in the finally obtained solid electrolyte. In addition, since ammonium fluoride can fluorinate the raw material at a low temperature (e.g., about 150° C.), the solid electrolyte can be synthesized without causing particle growth and sintering to proceed. Therefore, a solid electrolyte that is softer and finer than a solid electrolyte obtained by a solid-phase reaction from a fluoride raw material can be obtained. Thus, in the production method according to the first embodiment, by performing fluorination treatment on the raw material using the fluorine-containing substance, a solid electrolyte that can achieve densification and thinning of a compacted powder can be produced. When the obtained solid electrolyte is used for a solid electrolyte layer of a battery, further thinning and higher ionic conductivity of the solid electrolyte layer can be achieved, or the solid electrolyte can be suitably used for a coating layer for active material particles to achieve higher ionic conductivity of an electrode. Therefore, by using the solid electrolyte produced by the production method according to the first embodiment, a battery having improved conductivity and reliability and having good performance can be obtained. When a solid-phase reaction of the fluoride raw material is caused, it is difficult to generate a solid electrolyte including a crystal phase represented by the composition formula (1): Li₂TiF₆, for example, at a low temperature of about 150° C. or higher and 600° C. or lower, and at least a temperature higher than 600° C. (e.g., a temperature of about 600° C. to 800° C.) is required. Therefore, when solid-phase reaction of the fluoride raw material is caused, it is difficult to obtain a soft and fine solid electrolyte.

Furthermore, by using ammonium fluoride as the fluorine-containing substance, the energy for synthesis is saved, and the heating and cooling times are reduced, so that the productivity is also improved. Moreover, since the synthesis of the solid electrolyte at a low temperature is possible, the durability of the furnace material is improved, and the running cost and replacement frequency of a synthetic member are also significantly reduced. As the fluorine-containing substance, the ammonium salt by itself may be used.

The fluorine-containing substance may include a resin. By including a resin as the fluorine-containing substance, the fluorine-containing substance can fluorinate the raw material while being thermally decomposed at a relatively high temperature (e.g., about 450° C. or higher and 600° C. or lower). Therefore, the method in which the resin is included as the fluorine-containing substance is suitable for the case where it is desired to carry out the fluorination and the solid-phase reaction at a relatively high temperature (e.g., about 450° C. or higher and 600° C. or lower).

An example of the resin used as the fluorine-containing substance is a fluorine resin. For example, polytetrafluoroethylene (PTFE), polyvinylidene fluoride (PVDF), etc., can be used. The fluorine resin such as PTFE and PVDF can fluorinate the raw material while being thermally decomposed at a relatively high temperature (e.g., about 400° C. or higher and 600° C. or lower). Therefore, the method in which the fluorine resin is used as the fluorine-containing substance is suitable for the case where it is desired to carry out the fluorination and the solid-phase reaction at a relatively high temperature. For example, the case of PVDF is suitable for fluorination at 400° C. or higher, and the case of PTFE is suitable for fluorination at 500° C. or higher.

The fluorine-containing substance may include, for example, a substance from which the inorganic components generated by thermal decomposition during the heat treatment in the above (A), other than the fluorine element, are substantially not incorporated into the produced solid electrolyte. For the fluorine-containing substance used for the fluorination treatment, it is required that while the fluorine element generated by thermal decomposition during the heat treatment in the above (A) is replacing the oxygen element of the raw material, the other components are not incorporated as inorganic residues into the finally obtained solid electrolyte. By using, as the fluorine-containing substance, a substance from which the inorganic components generated by thermal decomposition during the heat treatment, other than the fluorine element, are substantially not incorporated into the finally obtained solid electrolyte, the incorporation of inorganic residues into the solid electrolyte can be suppressed, and the desired solid electrolyte can be obtained. Here, in this description, “the inorganic components generated by thermal decomposition during the heat treatment, other than the fluorine element, are substantially not incorporated into the produced solid electrolyte” means that the content ratio of the inorganic components in the solid electrolyte is 0.5 mass % or less.

The fluorine-containing substance may include a plurality of types of fluorine-containing compounds. For example, by using a plurality of types of fluorine-containing compounds having thermal decomposition properties different from each other, or by using a plurality of types of fluorine-containing compounds having particle sizes different from each other, the fluorination of the raw material can be appropriately performed. For example, both ammonium fluoride and the fluorine resin may be used as the fluorine-containing substance. Accordingly, the temperature range where the fluorine-containing substance acts as a fluorine source can be controlled to be wide, and thus the conversion of the raw material into the fluoride and the solid-phase reaction temperature can be controlled over a wide range. Therefore, it becomes easy to obtain the desired solid electrolyte.

The amount of the used fluorine-containing substance only has to be sufficient to fluorinate the entire amount of the compound to be fluorinated and is not particularly limited. For example, when the molar amount of the fluorine-containing substance for fluorinating all of the compound stoichiometrically (i.e., the molar amount equivalent stoichiometrically, in other words, the molar amount required to completely substitute the anion of the compound to be fluorinated with an F anion) in the reaction of fluorinating the compound to be fluorinated is defined as 100%, the amount of the fluorine-containing substance may be, for example 103% or more and 150% or less, may be 103% or more and 130% or less, or may be 103% or more and 110% or less.

### <(A-1)>

In (A-1), the raw material and the fluorine-containing substance are mixed. In the mixing of the raw material and the fluorine-containing substance, for example, the raw material including the composite oxide containing Li and Ti and the fluorine-containing substance having thermal decomposition properties are uniformly mixed.

By performing a step of uniformity mixing the raw material and the fluorine-containing substance as a preliminary step before the fluorination treatment as described above, the conversion from the raw material into the fluoride can be caused to uniformly occur. Accordingly, a homogeneous solid electrolyte can be synthesized.

In this preliminary step, pulverization treatment may be performed for the purpose of adjusting the particle size of the fluorine-containing substance. By micronizing a mixed powder, the synthesis temperature of the solid electrolyte can be decreased, for example, by about 10° C. to 50° C. Therefore, the sintering and the particle growth of the solid electrolyte can be further suppressed, so that a softer and finer solid electrolyte can be obtained.

For example, a powder of the raw material including the composite oxide containing Li and Ti and a powder of the fluorine-containing substance are mixed at a desired ratio. For example, the powders of the raw material and the fluorine-containing substance only have to be mixed such that these powders are homogeneous. For example, these powders may be uniformly mixed by repeated mixing with a spatula, or may be mixed using a mortar and a pestle, a grinding machine, a dry mixing device such as a V-blender, or the like. Alternatively, these powders may be mixed using a medium such as zirconia balls and be pulverized if necessary. As long as these powders can be mixed uniformly, any mixing means may be used. Uniformity can be evaluated, for example, using energy dispersive X-ray spectroscopy (EDS) or an electron probe microanalyzer (EPMA). For example, uniformity can be confirmed by observing a compositional mapping image.

### <(A-2)>

In (A-2), the fluorination treatment is performed on the raw material by performing the heat treatment on a mixture including the raw material and the fluorine-containing substance obtained in the above (A-1).

For the heat treatment, a general electric furnace may be used. If necessary, an atmosphere for the heat treatment may be selected, and the heat treatment may be performed in atmospheric air, an inert gas atmosphere (e.g., nitrogen gas or argon gas), or a reducing gas (e.g., hydrogen or carbon dioxide). The synthesized fluoride is normally obtained as a powder, but when the heat treatment is performed at a temperature equal to or higher than the melting point thereof, the fluoride may be obtained as a block-like mass formed by the adhesion of melts, sintered bodies, or powder.

In the heat treatment, for example, the above-described uniformly mixed mixture is placed in a heat-resistant container (sagger) made of alumina, and the mixture is fired using a firing furnace in any atmosphere. For example, an inert gas such as nitrogen gas is caused to flow into the furnace, and heat treatment is performed in the atmosphere furnace, for example, at a temperature of 200° C. or higher and 600° C. or lower, for example, for a time of 1 hour or longer and 40 hours or shorter, while the gases generated by fluorination (e.g., ammonium, hydrogen chloride, carbon dioxide, etc.) are discharged, to synthesize a solid electrolyte including a crystal phase represented by the composition formula (1): Li₂TiF₆. As described above, by introducing the gas into the firing furnace and discharging the gases therefrom, unnecessary reactive gas components, etc., are prevented from remaining in the furnace, that is, in the solid electrolyte.

It is preferable that the inert gas is introduced into the furnace such that the inert gas does not directly hit the sagger in which the mixture has been placed. Instead of the inert gas, atmospheric air may be introduced into the furnace. A plate larger than a gas introduction port is installed between the gas introduction port and the sagger. The thickness of the plate may be such a thickness that the plate is not damaged by gas flow or handling. For example, it is more preferable to partially shield by merely standing a plate such as an alumina plate upright. As a result of shielding between the gas introduction port and the sagger as described above, the gas comes into contact with the sagger after flowing around the shielding plate. By bringing the gas into indirect contact with the sagger after bypassing as described above, a problem that the temperature is decreased in the portion where the gas directly hits and the temperature distribution in the sagger is increased is reduced. Accordingly, nonuniformity of the distribution of a reaction progress (i.e., variation in the reaction progress) for the synthesis reaction of the solid electrolyte by the fluorination reaction and the solid-phase reaction of the raw material is suppressed.

It is preferable that the gas introduction port is installed on the bottom side of the furnace and an exhaust port is provided on the upper side (e.g., on the ceiling side or on the upper side of a side wall). Accordingly, the reactive gases can be smoothly discharged out of the furnace by utilizing the convection (bottom-to-top) flow in the furnace, so that incorporation of unnecessary residual components into the solid electrolyte can be reduced.

The gas to be introduced may be heated and then introduced into the furnace. Accordingly, nonuniformity of the temperature distribution in the sagger can be suppressed. Therefore, the synthesis reaction of the solid electrolyte is performed uniformly, so that a more homogeneous solid electrolyte can be obtained.

The heat treatment temperature is, for example, 200° C. or higher and 600° C. or lower as described above. The heat treatment time is, for example, 1 hour or longer and 40 hours or shorter as described above. When the heat treatment temperature is lowered and the treatment time is shortened, the sintering and the particle growth of the solid electrolyte do not proceed, so that a solid electrolyte composed of soft fine particles can be obtained. Through such production, a solid electrolyte with which a dense compacted powder having excellent ionic conductivity can be formed can be obtained. The heat treatment temperature and heat treatment time can be determined as desired in consideration of the properties (e.g., crystal system, powder characteristics, etc.) of the raw material, the properties (e.g., crystal system, powder characteristics, etc.) of the solid electrolyte to be synthesized, the temperature required for the synthesis of a solid electrolyte including a crystal phase represented by the composition formula (1): Li₂TiF₆, the time required for the synthesis, the discharge time of the reactive gases, etc.

As the furnace used for the heat treatment, a known firing furnace (e.g., electric furnace) or an atmosphere firing furnace can be used. In order to remove the atmospheric air and moisture between the particles deep in the sagger and completely replace the atmospheric air and moisture with the inert gas, the inert gas may be caused to flow after vacuum replacement. Accordingly, the influence of reactive components and moisture contained in the atmospheric air can be reduced. Vacuum replacement may be performed repeatedly.

The temperature distribution in the sagger during the heat treatment may be within the temperature distribution range of a generally used firing furnace, for example, 30° C. The temperature distribution in the sagger here is the difference between the highest temperature and the lowest temperature in the sagger.

The heat treatment is not for reacting materials that easily evaporate, such as titanium fluoride, and thus the heat treatment does not need to be performed in a sealed environment. The mixture of the raw material and the fluorine-containing substance may be placed in the sagger, a lid (e.g., an alumina lid) to prevent debris and foreign objects from falling may be placed if necessary, and the heat treatment may be performed. Therefore, unlike heat treatment in a conventional production method using a fluoride as a raw material such as a method in which the treatment amount is limited by size as in a seal-type heat treatment tool (i.e., heat treatment for causing a solid-phase reaction of the fluoride raw material), the heat treatment in the production method according to the first embodiment has very good productivity and workability and has possesses significant industrial applicability. With the production method according to the first embodiment, a solid electrolyte including a crystal phase represented by the composition formula (1): Li_{z}TiF₆, which has excellent ionic conductivity and stability (e.g., electrochemical stability and heat resistance) can be obtained since the method is such a production method having excellent productivity. In the case where the raw material contains a trace amount of titanium oxide as an impurity, a trace amount of a titanium fluoride (e.g., TiF₄) may be generated. However, by performing the heat treatment in an open atmosphere, that trace amount of titanium fluoride evaporates and disappears. Therefore, even in such a case, a solid electrolyte containing no titanium fluoride and having excellent characteristics and reliability can be obtained.

The material of the sagger does not have to be alumina. As the sagger, heat-resistant containers made of various dense (e.g., relative density of 98% or more) materials such as mullite and SiC in addition to alumina can be used. From the viewpoint of the reaction between the raw material, the fluorine-containing substance, and the solid electrolyte accommodated in the sagger and the sagger, a material suitable for the sagger may be selected. In addition to the above-described materials for the sagger, those that are dense, have heat resistance, and have a small heat capacity can be used as the material of the sagger. As the shape of the sagger, various shapes such as a cylindrical shape, a prismatic shape, and a gourd shape can be used.

Here, the example in which the sagger is used for the heat treatment has been described, but the present disclosure is not limited to this. For example, a rotary furnace such as a rotary kiln may be used, or a mixed powder may be sprayed to perform heat treatment, such as spray drying.

As an example of the production method according to the first embodiment, the method in which the above (A-1) and the above (A-2) are performed has been described in detail, but the step of uniformly mixing the raw material and the fluorine-containing substance in advance before the fluorination treatment does not necessarily have to be performed. For example, the fluorine-containing substance may be added to the raw material, and the heat treatment may be performed without sufficient mixing. In addition, it is desirable to perform the heat treatment for efficient fluorination treatment, but by adding the fluorine-containing substance to the raw material and then leaving the raw material at room temperature for a long time, the fluorination of the raw material may be performed.

The surface of the solid electrolyte synthesized by the fluorination treatment and not subsequently subjected to pulverization treatment as in a production method according to a second embodiment described later is a free surface. The free surface is not an active surface that is highly reactive and that is exposed after pulverization, and thus the stability of the surface is high. Such a solid electrolyte is stable and particularly has excellent environmental resistance (storage characteristics). Therefore, depending on the application and requirements, a pulverization step after fluorination can be omitted or added as appropriate, for example, pulverization treatment can be performed after long-term storage.

In the production method according to the first embodiment, an additive may be added to the raw material if necessary before the fluorination treatment. For example, an additive for promoting the fluorination reaction of the raw material, an additive for promoting the solid-phase reaction of the raw material, etc., may be added. In the case where the composite oxide containing Li and Ti used as the raw material is synthesized in the production method according to the first embodiment, the above additive may be added when the composite oxide containing Li and Ti used as the raw material is synthesized. Examples of such additives include an oxide containing at least one element selected from the group consisting of Zn, Mg, Nb, P, Ga, K, Na, Ca, Fe, Si, and Cu. For example, when a Zn oxide, an Mg oxide, an Nb oxide, and a P oxide are added to the raw material in small amounts, the reaction temperatures of the fluorination reaction and the solid-phase reaction can be decreased, for example, by about 10° C. to 20° C., and the reactivity of the fluorination reaction and the solid-phase reaction can be improved. Accordingly, the fluorination reaction and the solid-phase reaction of the raw material can be promoted. Two or more selected from the group consisting of the Zn oxide, the Mg oxide, the Nb oxide, and the P oxide may be added together, or only one selected from the group consisting of the Zn oxide, the Mg oxide, the Nb oxide, and the P oxide may be added. P can be diluted in a phosphoric acid aqueous solution and added. Accordingly, P can be added precisely in a small amount, or in the case of wet mixing, P can be uniformly dispersed. The addition amount of the additive may be selected as appropriate according to the compound to be added, the purpose thereof, etc., and thus is not particularly limited. For example, when the Zn oxide, the Mg oxide, the Nb oxide, and the P oxide are added for the purpose of promoting the fluorination reaction and the solid-phase reaction, the total of the addition amounts of the Zn oxide, the Mg oxide, the Nb oxide, and the P oxide may be, for example, 0.001 mol % or more and 0.3 mol % or less with respect to the raw material.

The additives such as the Zn oxide, the Mg oxide, the Nb oxide, and the P oxide may be, for example, in particle form. Depending on the particle form of each additive and the dispersion state of each additive with respect to the raw material, the action effect of the additive may vary. As for the Zn oxide, the Mg oxide, the Nb oxide, and the P oxide, in general, the smaller the particle size is, the higher the obtained effects of the additives such as reaction-promoting effects are. For example, the particle diameter of each additive may be smaller than that of the particles of the composite oxide included in the raw material. As an example, the additive may be fine particles having a particle diameter of 0.1 μm or less and a BET specific surface area of 100 m²/g or more. When the Zn oxide, the Mg oxide, the Nb oxide, and the P oxide are used as coarse particles or excessively added, undesired precipitate phases other than solid electrolytes may be generated and ionic conductivity may be reduced. Therefore, it is desirable to adjust the particle size and the addition amount to an appropriate size and amount. Zn, Mg, Nb, and P derived from the Zn oxide, the Mg oxide, the Nb oxide, and the P oxide added as the additives, for example, each act as an aid for conversion into the fluoride and solid-phase reaction and are taken into the solid electrolyte. For example, it is desirable that for the Zn oxide, the Mg oxide, the Nb oxide, and the P oxide, the particle size and the addition amount should be set to a size and an amount with which Zn, Mg, Nb, and P are not detected as composition phases in X-ray diffraction measurement of the finally obtained solid electrolyte. Accordingly, a solid electrolyte having high ionic conductivity can be synthesized while obtaining a reaction-promoting effect.

In the production method according to the first embodiment, in the case where at least one selected from the group consisting of the Zn oxide, the Mg oxide, the Nb oxide, and the P oxide is used as an additive, the obtained solid electrolyte contains at least one selected from the group consisting of Zn, Mg, Nb, and P. That is, in this case, the solid electrolyte obtained by the production method according to the first embodiment includes a crystal phase represented by the composition formula (1): Li₂TiF₆ and further contains at least one selected from the group consisting of Zn, Mg, Nb, and P. Owing to this configuration, a homogeneous solid electrolyte having excellent ionic conductivity is obtained.

The amount of oxygen as an impurity in the solid electrolyte obtained by the production method according to the first embodiment may be 0.5 mass % or less. With the production method according to the first embodiment, a solid electrolyte into which a small amount of oxygen is incorporated can be obtained. The amount of oxygen as an impurity in the solid electrolyte may be, for example, 0.1 mass % or more.

As described above, in the case where at least one selected from the group consisting of the Zn oxide, the Mg oxide, the Nb oxide, and the P oxide is added as an additive for promoting the reaction of the raw material, Zn, Mg, Nb, and P are not detected as composition phases in X-ray diffraction measurement in some cases. Even in such a case, the fact that the solid electrolyte contains Zn, Mg, Nb, and P can be confirmed by high-sensitivity compositional analysis (area analysis or the like) such as by using an electron probe microanalyzer (EPMA). The total of the content ratios of Zn, Mg, Nb, and P contained in the solid electrolyte may be 0.0003 at. % or more and 0.3 at. % or less. The content ratios of Zn, Mg, Nb, and P can be obtained by EPMA or the like.

It is desirable that the solid electrolyte obtained by the production method according to the first embodiment should be substantially free of TiF₄.

The solid electrolyte obtained by the production method according to the first embodiment may be a solid electrolyte that includes a crystal phase represented by the composition formula (1): Li₂TiF₆ and that is substantially free of TiF₄. Here, “the solid electrolyte is substantially free of TiF₄” means that the content ratio of TiF₄ in the solid electrolyte is, for example, 0.5 mass % or less and desirably 0.1 mass % or less. The content ratio of TiF₄ in the solid electrolyte is obtained, for example, from the area ratio of a TiF₄ portion detected by performing compositional analysis for a cross-section of a compacted powder of the solid electrolyte or the particle surface of the solid electrolyte through elemental analysis by energy dispersive X-ray spectroscopy (EDS) or an electron probe microanalyzer (EPMA). Owing to this configuration, temporal changes in characteristics, mechanical properties, etc., of the solid electrolyte caused by evaporation and deliquescence of TiF₄ can be suppressed, so that a solid electrolyte having excellent ionic conductivity and reliability can be realized. In the case where the raw material, which is a raw material of the solid electrolyte, contains a trace amount of titanium oxide (TiO₂), a trace amount of TiF₄ may be generated in the fluorination process. However, even in this case, by performing the fluorination treatment in an open atmosphere, TiF₄ can be caused to evaporate and disappear. Therefore, a solid electrolyte that is substantially free of TiF₄ and has excellent characteristics and reliability can be obtained.

The solid electrolyte obtained by the production method according to the first embodiment may be substantially free of TiF₄ and composed of a single phase of a crystal phase represented by the composition formula (1): Li₂TiF₆. The fact that the solid electrolyte obtained by the production method according to the first embodiment is composed of a single phase of a crystal phase represented by the composition formula (1): Li_{z}TiF₆ can be confirmed by an X-ray diffraction pattern obtained by X-ray diffraction measurement. The X-ray diffraction pattern can be measured by the 0-20 method using Cu-Kα rays (wavelengths: 1.5405 Å and 1.5444 Å) as X-ray sources. Specifically, this fact can be confirmed by the fact that, in the X-ray diffraction pattern, only a peak derived from Li₂TiF₆ exists, and no peaks derived from other crystal phases exist. Here, in the present disclosure, a peak in an X-ray diffraction pattern is defined as an angle indicating the maximum intensity of a mountain-shaped portion in which an SN ratio (i.e., the ratio of signal S to background noise N) has a value of 1.3 or more and a full width at half maximum is 10° or less. The full width at half maximum is a width represented by the difference between two diffraction angles at which, when the maximum intensity of an X-ray diffraction peak is denoted by IMAX, the intensity is half of IMAX. For peaks having a full width at half maximum of greater than 5°, the peaks are considered not to exist.

As described above, in the production method according to the first embodiment, in the case where at least one selected from the group consisting of the Zn oxide, the Mg oxide, the Nb oxide, and the P oxide is used as an additive, the obtained solid electrolyte includes a crystal phase represented by the composition formula (1): Li₂TiF₆ and further contains at least one selected from the group consisting of Zn, Mg, Nb, and P. It is also desirable that such a solid electrolyte should be substantially free of TiF₄.

The solid electrolyte obtained by the production method according to the first embodiment may be in particle form. Owing to this configuration, a relatively soft particulate solid electrolyte can be realized. Therefore, a compacted powder of such a solid electrolyte has high ionic conductivity and excellent stability and can take any shape. Therefore, with the compacted powder of the solid electrolyte having such characteristics, a solid electrolyte layer of a battery or a coating layer for active material particles which has excellent characteristics and high reliability can be realized. Accordingly, with the solid electrolyte obtained by the production method according to the first embodiment, a battery having high performance and high reliability is realized. The size and shape of the solid electrolyte particles can be selected as appropriate according to the application.

The solid electrolyte obtained by the production method according to the first embodiment includes a crystal phase represented by the composition formula (1): Li₂TiF₆. This crystal phase includes, for example, a first crystal phase belonging to the tetragonal crystal system. Owing to this configuration, a solid electrolyte having high ionic conductivity can be obtained. In addition, the solid electrolyte can have heat resistance in the range of about 250° C. to 300° C., so that a battery having high reliability can be obtained. The solid electrolyte obtained by the production method according to the first embodiment may further include a second crystal phase having a crystal system different from that of the first crystal phase.

The solid electrolyte obtained by the production method according to the first embodiment may include an amorphous phase. Owing to this configuration, the amorphized part of the solid electrolyte becomes softer, has more excellent deformability, and has improved interparticle bonding. Therefore, with a compacted powder of the solid electrolyte, a solid electrolyte layer having higher ionic conductivity and higher stability can be formed in any shape. Thus, in the case where the solid electrolyte includes an amorphous phase, a solid electrolyte layer of a battery or a coating layer for active material particles which has excellent characteristics and high reliability can be realized with a compacted powder of this solid electrolyte. As a result, a battery having high performance and high reliability is realized.

When the production method according to the first embodiment is compared with the production methods described in Patent Literature 1 and Non Patent Literature 1, there are the following differences.

Patent Literature 1 discloses a halide solid electrolyte such as Li₃YBr₃Cl₃ and a production method therefor. The halide solid electrolyte such as Li₃YBr₃Cl₃ is synthesized from a raw material including simple oxide Y₂O₃ and further including NH₄Cl, LiBr, etc. Unlike a method using a composite oxide as in the production method for a solid electrolyte according to the first embodiment, in the case of a method in which a halide containing multiple cations is synthesized using a simple oxide (i.e., an oxide in which the cation is one type) and multiple simple halides (i.e., halides in which the cation is one type) as disclosed in Patent Literature 1, the conditions for halogenation (i.e., the behavior of halogenation) differ for each simple oxide and simple halide. That is, a reaction of an aggregate of substances whose conditions for halogenation differ from each other takes place. Thus, there is a problem that a reaction path becomes complicated, intermediate compounds generated during the process are likely to remain, and it is difficult to obtain a solid electrolyte having a target composition.

Also, Non Patent Literature 1 discloses a solid electrolyte represented by a composition of LiYF₄ and a production method therefor. LiYF₄ is synthesized by a solid-phase reaction using Li₂CO₃, Y₂O₃, and NH₄F. There are differences in the behavior of halogenation between Li₂CO₃ and Y₂O₃, and thus there is a problem similar to that of the method described in Patent Literature 1.

The production method for a solid electrolyte according to the first embodiment solves the above problem of the production methods described in Patent Literature 1 and Non Patent Literature 1 and is a synthesis method that uses a precursor oxide containing multiple cations (e.g., Li₂TiO₃) as a raw material to convert the precursor oxide into a fluoride. Therefore, the production method according to the first embodiment is clearly different from the production methods disclosed in Patent Literature 1 and Non Patent Literature 1 and allows a halide solid electrolyte having a target composition to be stably synthesized.

### Second Embodiment

Hereinafter, a production method for a solid electrolyte according to a second embodiment will be described.

The production method according to the second embodiment further includes, after the above (A) in the production method according to the first embodiment,

(B) performing pulverization treatment on the solid electrolyte obtained in the above (A).

In the production method according to the second embodiment, by performing the pulverization treatment in the above (B), a solid electrolyte having excellent ionic conductivity and reliability can be obtained with powder characteristics (e.g., particle shape, particle size, etc.) suitable for the application. In addition, at least a part of the solid electrolyte can be amorphized, so that ionic conductivity can be improved and the softness of the particles of the solid electrolyte can be improved. By improving the softness of the particles of the solid electrolyte, the density of a compacted powder of the solid electrolyte can be improved. Therefore, with the solid electrolyte obtained by the production method according to the second embodiment, a dense compacted powder having high ionic conductivity can be formed.

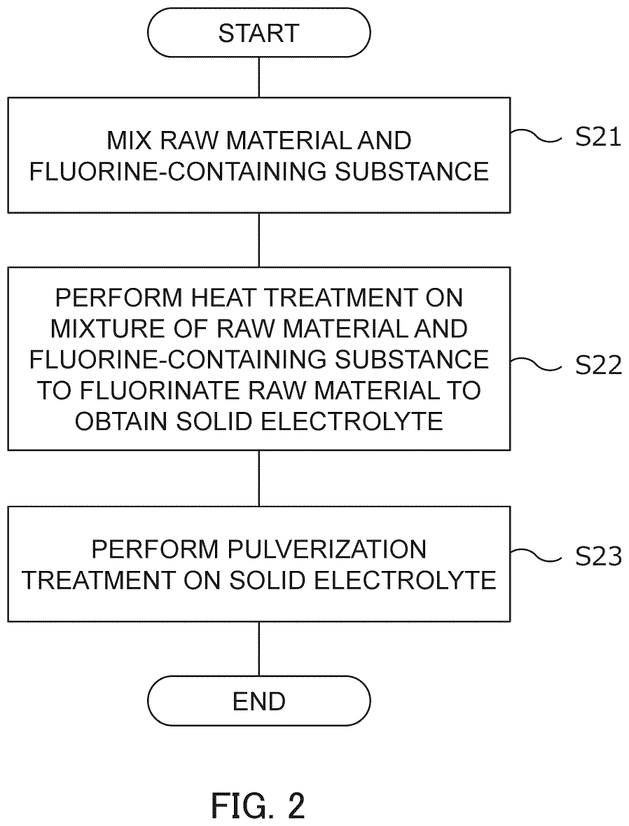

FIG. 2 is a flowchart showing an example of the production method for a solid electrolyte according to the second embodiment. Here, an example of a production method in which the above (B) is performed after the above (A-2) in the production method in which the above (A-1) and the above (A-2) are performed as the above (A) and which is an example of the production method described in the first embodiment, will be described.

As shown in FIG. 2, first, a raw material and a fluorine-containing substance are mixed (S21). Next, fluorination treatment is performed on the raw material by performing heat treatment on the obtained mixture including the raw material and the fluorine-containing substance (S22). Accordingly, a solid electrolyte including a crystal phase represented by the composition formula (1): Li₂TiF₆ is obtained. Next, as a step corresponding to the above (B), pulverization treatment is performed on the solid electrolyte obtained in S22 (S23).

S21 and S22 are the same as S11 and S12 described in the first embodiment, respectively, and thus the detailed description thereof is omitted here.

The solid electrolyte synthesized by the above (A) has an average particle diameter of about 3 μm or more and 20 μm or less, for example. In the above (B), pulverization treatment is performed on such a solid electrolyte synthesized by the above (A), for example, such that the average particle diameter thereof becomes about 0.1 μm or more and 2 μm or less.

The solid electrolyte pulverized in the above (B) includes, for example, fine particles having a BET specific surface area of 2.0 m²/g or more and 30 m²/g or less. Such a solid electrolyte has characteristics of excellent ionic conductivity and excellent stability in atmospheric air, is soft and therefore deformable, and can also be pulverized. Therefore, the solid electrolyte is useful for solid electrolyte layers, composite components of active material layers, and coating layers for active material particles. Thus, higher performance and higher reliability of a battery are achieved. The solid electrolyte pulverized in the above (B) includes, for example, fine particles having a BET specific surface area of 4.0 m²/g or more and 150 m²/g or less.

The pulverization treatment only has to be performed such that the fluoride can be pulverized into small pieces having the desired particle size and may be performed by a dry method or a wet method using water or a solvent (e.g., ethanol, butyl acetate, or the like). For example, zirconia balls (e.g., balls with a diameter of 1 mm to 30 mm) and the solid electrolyte obtained in the above (A) are placed in a ball mill container, and the solid electrolyte is pulverized for 4 to 80 hours, for example. As the ball mill container, for example, a container made of polyethylene, a container lined with a fluorine resin or zirconia, etc., can be used.

The pulverization treatment in the above (B) may include, for example, mechanochemical treatment. Here, the mechanochemical treatment is performed in order to introduce distorted crystals or amorphous properties to the crystals of the solid electrolyte. Distorted crystals or amorphous properties are mainly introduced into the surface layers of the particles of the solid electrolyte. The specific means for this may be the same as in the pulverization treatment described above, and, for example, a ball mill is used. However, the pulverization conditions may be strengthened or the time may be extended. A device, a medium, etc., used for the mechanochemical treatment may be the same as in the pulverization treatment, and in general, pulverization and the mechanochemical treatment proceed at the same time. As an example, in the case of a dry method, a container lined with zirconia is used, zirconia balls with a volume ratio of 10% to 60% are placed therein, and mechanochemical milling is performed along with pulverization. The diameter of the zirconia balls is not particularly limited and balls with any size can be used. Normally, as described above, commercially available balls with a diameter of 1 mm to 30 mm are used, but balls having a smaller diameter than these balls may be used, or balls having a larger diameter than these balls may be used. The diameter of the balls to be used may be selected as desired according to a target particle size or degree of amorphization. In addition, an appropriate amount of an additive that does not adversely affect the characteristics of the solid electrolyte, such as ethanol, may be added in order to suppress the adhesion of the solid electrolyte to the zirconia balls or the inner wall of the zirconia container. The additive is preferably an additive that can be dried and removed later.

The introduction of amorphous properties into the solid electrolyte can be confirmed by an X-ray diffraction pattern obtained by X-ray diffraction measurement. The X-ray diffraction pattern can be measured by the 0-20 method using Cu-Kα rays (wavelengths: 1.5405 Å and 1.5444 Å) as X-ray sources. Specifically, this introduction can be confirmed by the fact that the peak of an X-ray diffraction pattern of the solid electrolyte after the pulverization treatment widens compared with the peak of an X-ray diffraction pattern of the solid electrolyte before the pulverization treatment is performed. The fact that the peak widens means that the peak is broad and the full width at half maximum widens.

The introduction of distorted crystals into the solid electrolyte, that is, the presence of disturbed crystalline regions, can be observed by a transmission electron microscope (TEM) as images of highly regular regions of a lattice image and disturbed regions of the lattice image.

In addition, changes in deformability due to amorphization can be evaluated by evaluation methods such as Micro-Vickers.

As described above, the production method according to the second embodiment includes the pulverization treatment, and thus the solid electrolyte obtained by the production method according to the second embodiment includes, for example, an amorphous phase. Owing to this configuration, the amorphized part of the solid electrolyte becomes even softer and has excellent deformability. Therefore, with a compacted powder of the solid electrolyte, a solid electrolyte layer having higher ionic conductivity and higher stability can be formed in any shape. Therefore, with the compacted powder of the solid electrolyte including the amorphous phase, a solid electrolyte layer of a battery having excellent characteristics and high reliability can be realized.

As a modification of the production method according to the second embodiment, when performing the pulverization treatment in the above (B), the solid electrolyte may be slurried, for coating film formation, simultaneously with the pulverization treatment.

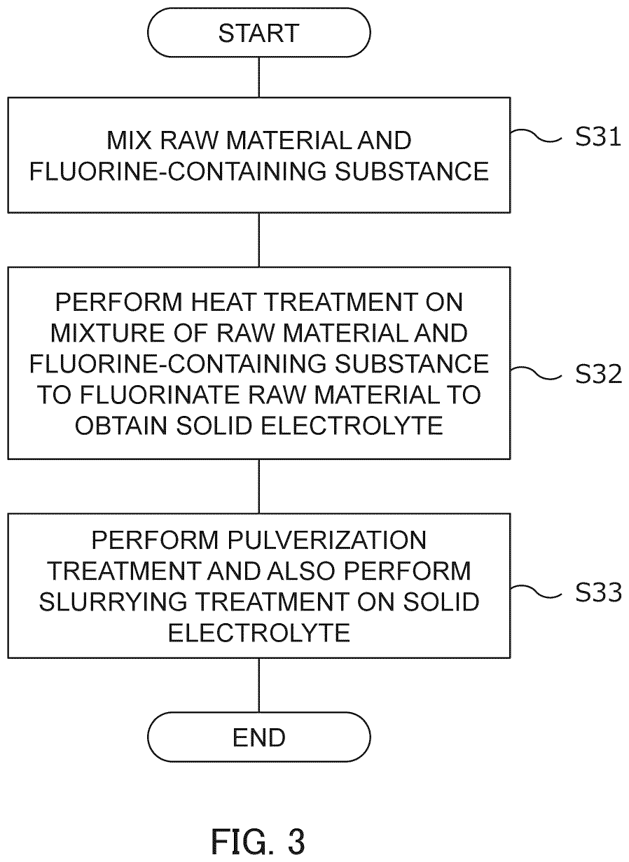

FIG. 3 is a flowchart showing a modification of the production method for a solid electrolyte according to the second embodiment. As for the modification of the production method according to the second embodiment as well, an example of a production method in which the above (B) is performed after the above (A-2) in the production method in which the above (A-1) and the above (A-2) are performed as the above (A) and which is an example of the production method described in the first embodiment, will be described here.

As shown in FIG. 3, first, a raw material and a fluorine-containing substance are mixed (S31). Next, fluorination treatment is performed on the raw material by performing heat treatment on the obtained mixture including the raw material and the fluorine-containing substance (S32). Accordingly, a solid electrolyte including a crystal phase represented by the composition formula (1): Li₂TiF₆ is obtained. Next, as a step corresponding to the above (B), on the solid electrolyte obtained in S32, pulverization treatment is performed and slurrying treatment is also performed (S33).

S31 and S32 are the same as S11 and S12 described in the first embodiment, respectively, and thus the detailed description thereof is omitted here.

In S33, the pulverization treatment is the same as the pulverization treatment in S23 described as an example of the production method of the second embodiment. In the modification of the production method of the second embodiment, the slurrying treatment is further performed. The slurrying treatment is performed, for example, by, simultaneously with the pulverization treatment, adding an organic binder, a plasticizer, or the like to the solid electrolyte in a state of being dispersed and included in an organic solvent such as tetralin. An example of the organic binder is a styrene butadiene block copolymer (SBS), for example. Examples of the plasticizer include dibutyl phthalate (DBP) and butyl benzyl phthalate (BBP).

Using the obtained slurry of the solid electrolyte, printing or coating can be performed. The thickness of a coating film may be, for example, 10 μm or more and 100 μm or less, and thus, for example, the slurry of the pulverized solid electrolyte including the amorphous part can be directly applied. As described above, in the pulverization treatment, a slurry of the solid electrolyte may be prepared by adding the organic binder, the plasticizer, or the like, and a coating film may be formed using this slurry. Accordingly, a coating film of the solid electrolyte having excellent characteristics can be formed. Such a coating film can be used, for example, for the manufacture of coated-type cells.

### Third Embodiment

Hereinafter, a production method for a solid electrolyte according to a third embodiment will be described.

In the production method according to the third embodiment, fluorine gas is generated by performing heat treatment on the fluorine-containing substance in the above (A) described in the first embodiment, and the fluorine gas is brought into contact with the raw material, thereby performing fluorination treatment on the raw material. In the production method according to the third embodiment, the pulverization treatment in the above (B) described in the second embodiment may be performed after the above (A).

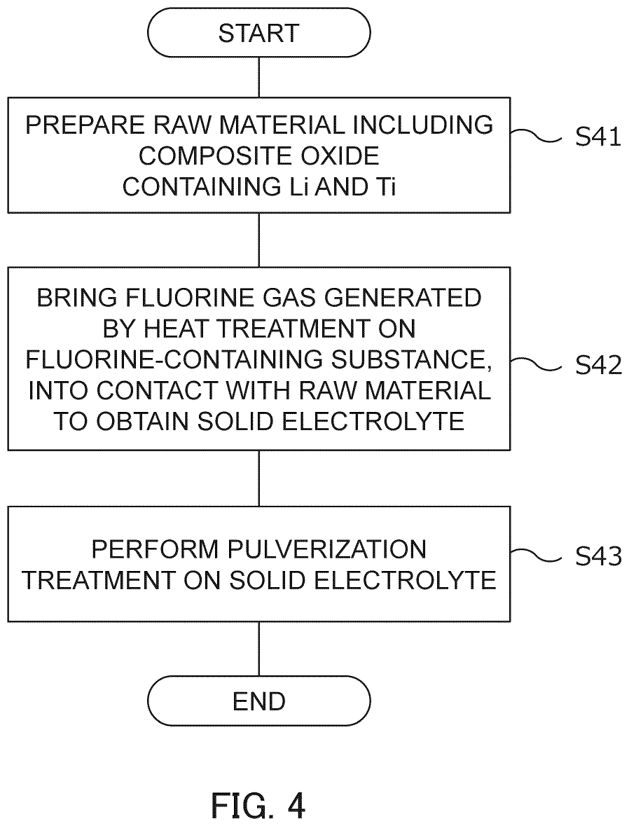

FIG. 4 is a flowchart showing an example of the production method for a solid electrolyte according to the third embodiment. As shown in FIG. 4, a raw material including a composite oxide containing Li and Ti is prepared (S41). Next, the raw material and the fluorine-containing substance are placed at a predetermined position, heat treatment is performed on the fluorine-containing substance, and generated fluorine gas is brought into contact with the raw material (S42). Accordingly, fluorination treatment on the raw material is performed. Then, as a step corresponding to the above (B), pulverization treatment may be performed on the solid electrolyte obtained in S42 (S43).

In the production method according to the third embodiment, the raw material can be fluorinated by the generated fluorine gas without bringing the raw material into direct contact with the fluorine-containing substance. Therefore, even when a fluorine-containing substance containing an inorganic component in addition to a fluorine element (e.g., a substance that emits fluorine gas when heated, such as CuF2) is used, there is no need to consider inorganic residues being incorporated into the solid electrolyte to be produced. Therefore, the range of fluorine-containing substances that can be used can be expanded.

As a specific example, the raw material is placed, for example, on a nickel mesh with fine openings, and the fluorine-containing substance such as ammonium fluoride is placed under the nickel mesh. Thus, the raw material and the fluorine-containing substance are placed without contact with each other. In this state, by performing the heat treatment on the fluorine-containing substance, fluorine gas is generated, and this gas passes through the nickel mesh and comes into contact with the raw material. Accordingly, the raw material is converted into a fluoride. The raw material and the fluorine-containing substance are as described in the first embodiment. The heat treatment can be performed in atmospheric air, but heat treatment in a nitrogen atmosphere or reducing atmosphere is preferable in order to prevent the nickel mesh from oxidizing.

### Fourth Embodiment

Hereinafter, a fourth embodiment will be described. The matters described in the first embodiment, the second embodiment, and the third embodiment are omitted as appropriate.

A battery according to the fourth embodiment includes a positive electrode, an electrolyte layer, and a negative electrode. The electrolyte layer is provided between the positive electrode and the negative electrode.

At least one selected from the group consisting of the positive electrode, the electrolyte layer, and the negative electrode includes a solid electrolyte that includes a crystal phase represented by the composition formula (1): Li₂TiF₆ and is substantially free of TiF₄, or a solid electrolyte that includes a crystal phase represented by the composition formula (1): Li₂TiF₆ and further contains at least one selected from the group consisting of

Zn, Mg, Nb, and P. The solid electrolyte can be produced by the production method according to the first embodiment, the second embodiment, or the third embodiment. Hereinafter, the solid electrolyte that includes a crystal phase represented by the composition formula (1): Li₂TiF₆ and is substantially free of TiF₄, or the solid electrolyte that includes a crystal phase represented by the composition formula (1): Li₂TiF₆ and further contains at least one selected from the group consisting of Zn, Mg, Nb, and P, which is included in the battery according to the fourth embodiment, is referred to as solid electrolyte according to the fourth embodiment.

The solid electrolyte according to the fourth embodiment is one described as an example of the solid electrolyte that can be produced by the production method according to the first embodiment, the second embodiment, or the third embodiment, in the first embodiment, the second embodiment, or the third embodiment. The solid electrolyte according to the fourth embodiment may be in particle form. In addition, the solid electrolyte according to the fourth embodiment may include an amorphous phase as described in the second embodiment.

Owing to including the solid electrolyte according to the fourth embodiment, the battery according to the fourth embodiment has excellent charge and discharge characteristics.

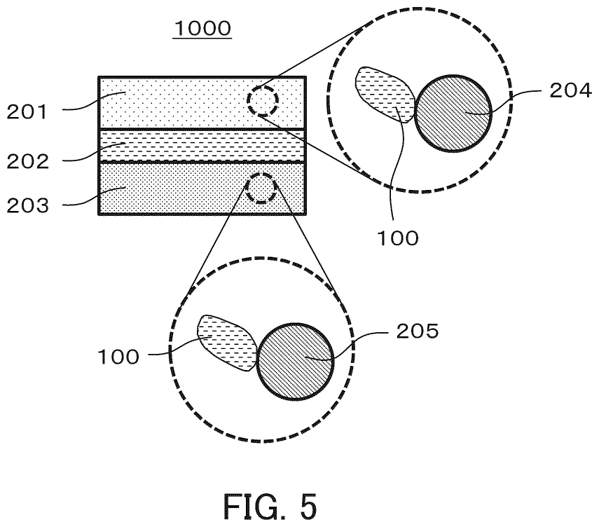

FIG. 5 illustrates a cross-sectional view of a battery 1000 according to the fourth embodiment.

The battery 1000 according to the fourth embodiment includes a positive electrode 201, an electrolyte layer 202, and a negative electrode 203. The electrolyte layer 202 is provided between the positive electrode 201 and the negative electrode 203.

The positive electrode 201 may include a positive electrode material including a halide electrolyte according to the fourth embodiment. The positive electrode 201 includes a positive electrode active material 204 and a solid electrolyte 100.

The electrolyte layer 202 includes an electrolyte material.

The negative electrode 203 includes a negative electrode active material 205 and the solid electrolyte 100.

The solid electrolyte 100 includes, for example, the solid electrolyte according to the fourth embodiment. The solid electrolyte 100 may be particles including the solid electrolyte according to the fourth embodiment as a main component. The particles including the solid electrolyte according to the fourth embodiment as a main component mean particles in which the component included in the largest amount in molar ratio is the solid electrolyte according to the fourth embodiment. The solid electrolyte 100 may be particles consisting of the solid electrolyte according to the fourth embodiment.

The positive electrode 201 includes a material capable of occluding and releasing metal ions (e.g., lithium ions). The material is, for example, the positive electrode active material 204.

Examples of the positive electrode active material 204 include a lithium-containing transition metal oxide, a transition metal fluoride, polyanion, a fluorinated polyanion material, a transition metal sulfide, a transition metal oxyfluoride, a transition metal oxysulfide, and a transition metal oxynitride. Examples of the lithium-containing transition metal oxide include Li(Ni, Co, Mn)O₂, Li(Ni, Co, Al)O₂, and LiCoO₂.

In the present disclosure, “(A, B, C)” means “at least one selected from the group consisting of A, B, and C”.

The shape of the positive electrode active material 204 is not limited to a specific shape. The positive electrode active material 204 may be particles. The positive electrode active material 204 may have a median diameter of 0.1 μm or more and 100 μm or less. In the case where the positive electrode active material 204 has a median diameter of 0.1 μm or more, the positive electrode active material 204 and the solid electrolyte 100 can be well dispersed in the positive electrode 201. Accordingly, the charge and discharge characteristics of the battery 1000 are improved. In the case where the positive electrode active material 204 has a median diameter of 100 μm or less, the diffusion rate of lithium in the positive electrode active material 204 improves. Accordingly, the battery 1000 can operate at a high power.

The positive electrode active material 204 may have a median diameter larger than that of the solid electrolyte 100. Accordingly, the positive electrode active material 204 and the solid electrolyte 100 can be well dispersed in the positive electrode 201.

In order to improve the energy density and power output of the battery 1000, the ratio of the volume of the positive electrode active material 204 to the total of the volume of the positive electrode active material 204 and the volume of the solid electrolyte 100 in the positive electrode 201 may be 0.30 or more and 0.95 or less.

A coating layer may be formed on at least a part of the surface of the positive electrode active material 204. The coating layer can be formed on the surface of the positive electrode active material 204, for example, before mixing a conductive additive and a binder. Examples of a coating material included in the coating layer include a sulfide solid electrolyte, an oxide solid electrolyte, and a solid electrolyte. In the case where the solid electrolyte 100 includes a sulfide solid electrolyte, the coating material may include the solid electrolyte according to the fourth embodiment to suppress oxidative decomposition of the sulfide solid electrolyte. In the case where the solid electrolyte 100 includes the solid electrolyte according to the fourth embodiment, the coating material may include an oxide solid electrolyte to suppress oxidative decomposition of the solid electrolyte. As the oxide solid electrolyte, lithium niobate having excellent high-potential stability may be used. By suppressing oxidative decomposition, an increase in overvoltage of the battery 1000 can be suppressed.

As described above, in the case where the positive electrode 201 includes a positive electrode material including the solid electrolyte according to the fourth embodiment, the positive electrode material may include the solid electrolyte according to the fourth embodiment as the solid electrolyte 100 or may include a coating material that coats the positive electrode active material 204.

In order to improve the energy density and power output of the battery 1000, the positive electrode 201 may have a thickness of 10 μm or more and 500 μm or less.

The electrolyte layer 202 includes an electrolyte material. The electrolyte material is, for example, a solid electrolyte. The solid electrolyte may include the solid electrolyte according to the fourth embodiment. The electrolyte layer 202 may be a solid electrolyte layer.

The electrolyte layer 202 may include 50 mass % or more of the solid electrolyte according to the fourth embodiment. The electrolyte layer 202 may include 70 mass % or more of the solid electrolyte according to the fourth embodiment. The electrolyte layer 202 may include 90 mass % or more of the solid electrolyte according to the fourth embodiment. The electrolyte layer 202 may consist only of the solid electrolyte according to the fourth embodiment.

Hereinafter, the solid electrolyte according to the fourth embodiment is referred to as first solid electrolyte. A solid electrolyte different from the first solid electrolyte is referred to as second solid electrolyte.

The electrolyte layer 202 may include not only the first solid electrolyte but also the second solid electrolyte. In the electrolyte layer 202, the first solid electrolyte and the second solid electrolyte may be uniformly dispersed. A layer consisting of the first solid electrolyte and a layer consisting of the second solid electrolyte may be stacked together along the stacking direction of the battery 1000.

The battery according to the fourth embodiment may include the positive electrode 201, a second electrolyte layer, a first electrolyte layer, and the negative electrode 203 in this order. Here, the solid electrolyte included in the first electrolyte layer may have a lower reduction potential than the solid electrolyte included in the second electrolyte layer. Accordingly, the solid electrolyte included in the second electrolyte layer can be used without being reduced. As a result, the charge and discharge efficiency of the battery 1000 can be improved. For example, in the case where the second electrolyte layer includes the first solid electrolyte, the first electrolyte layer may include a sulfide solid electrolyte to suppress reductive decomposition of the solid electrolyte. Accordingly, the charge and discharge efficiency of the battery 1000 can be improved. The second electrolyte layer may include the first solid electrolyte. The first solid electrolyte has high oxidation resistance, so that a battery having excellent charge and discharge characteristics can be realized.

The electrolyte layer 202 may consist only of the second solid electrolyte.

The electrolyte layer 202 may have a thickness of 1 μm or more and 1000 μm or less. In the case where the electrolyte layer 202 has a thickness of 1 μm or more, the positive electrode 201 and the negative electrode 203 are less likely to short circuit. In the case where the electrolyte layer 202 has a thickness of 1000 μm or less, the battery 1000 can operate at a high power.

Examples of the second solid electrolyte include Li₂MgX₄, Li₂FeX₄, Li(Al, Ga, In)X₄, Li₃(Al, Ga, In)X₆, and LiI, where X is at least one selected from the group consisting of F, CI, Br, and I.

In order to improve the energy density and power output of the battery 1000, the electrolyte layer 202 may have a thickness of 1 μm or more and 1000 μm or less.

The negative electrode 203 includes a material capable of occluding and releasing metal ions (e.g., lithium ions). The material is, for example, the negative electrode active material 205.

Examples of the negative electrode active material 205 include a metal material, a carbon material, an oxide, a nitride, a tin compound, and a silicon compound. The metal material may be an elemental metal or an alloy. Examples of the metal material include lithium metal and a lithium alloy. Examples of the carbon material include a natural graphite, a coke, a semi-graphitized carbon, a carbon fiber, a spherical carbon, an artificial graphite, and an amorphous carbon. From the viewpoint of capacity density, preferred examples of the negative electrode active material include silicon (i.e., Si), tin (i.e., Sn), a silicon compound, and a tin compound.

The negative electrode active material 205 may be selected in consideration of the reduction resistance of the solid electrolyte material included in the negative electrode 203. For example, in the case where the negative electrode 203 includes the first solid electrolyte, the negative electrode active material 205 may be a material capable of occluding and releasing lithium ions at 0.27 V or more with respect to lithium. Examples of such a negative electrode active material include a titanium oxide, indium metal, and a lithium alloy. Examples of the titanium oxide include Li₄Ti₅O₁₂, LiTi₂O₄, and TiO₂. By using the above negative electrode active material, reductive decomposition of the first solid electrolyte included in the negative electrode 203 can be suppressed. As a result, the charge and discharge efficiency of the battery 1000 can be improved.

The shape of the negative electrode active material 205 is not limited to a specific shape. The negative electrode active material 205 may be particles. The negative electrode active material 205 may have a median diameter of 0.1 μm or more and 100 μm or less. In the case where the negative electrode active material 205 has a median diameter of 0.1 μm or more, the negative electrode active material 205 and the solid electrolyte 100 can be well dispersed in the negative electrode 203. Accordingly, the charge and discharge characteristics of the battery 1000 are improved. In the case where the negative electrode active material 205 has a median diameter of 100 μm or less, the diffusion rate of lithium in the negative electrode active material 205 improves. Accordingly, the battery 1000 can operate at a high power.

The negative electrode active material 205 may have a median diameter larger than that of the solid electrolyte 100. Accordingly, the negative electrode active material 205 and the solid electrolyte 100 can be well dispersed in the negative electrode 203.

In order to improve the energy density and power output of the battery 1000, the ratio of the volume of the negative electrode active material 205 to the total of the volume of the negative electrode active material 205 and the volume of the solid electrolyte 100 in the negative electrode 203 may be 0.30 or more and 0.95 or less.

In order to improve the energy density and power output of the battery 1000, the negative electrode 203 may have a thickness of 10 μm or more and 500 μm or less.

At least one selected from the group consisting of the positive electrode 201, the electrolyte layer 202, and the negative electrode 203 may include the second solid electrolyte for the purpose of increasing ionic conductivity, chemical stability, and electrochemical stability.

The second solid electrolyte may be a sulfide solid electrolyte.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂.

In the case where the electrolyte layer 202 includes the first solid electrolyte, the negative electrode 203 may include a sulfide solid electrolyte to suppress reductive decomposition of the solid electrolyte. By covering the negative electrode active material with the sulfide solid electrolyte which is electrochemically stable, contact of the first solid electrolyte with the negative electrode active material can be suppressed. As a result, the internal resistance of the battery 1000 can be reduced.

The second solid electrolyte may be an oxide solid electrolyte.

Examples of the oxide solid electrolyte include:
(i) a NASICON solid electrolyte such as LiTi₂(PO₄)₃ and element-substituted substances thereof;
(ii) a perovskite solid electrolyte such as (LaLi) TiO₃;
(iii) a LISICON solid electrolyte such as Li₁₄ZnGe₄O₁₆, Li₄SiO₄, and LiGeO₄ and element-substituted substances thereof;
(iv) a garnet solid electrolyte such as Li₇La₃Zr₂O₁₂ and element-substituted substances thereof; and
(v) Li₃PO₄ and N-substituted substances thereof.

As described above, the second solid electrolyte may be a halide solid electrolyte. Examples of the halide solid electrolyte include Li₂MgX₄, Li₂FeX₄, Li(Al, Ga, In)X₄, Li₃(Al, Ga, In)X₆, and LiI, where X is at least one selected from the group consisting of F, Cl, Br, and I.

Another example of the halide solid electrolyte is a compound represented by LiₐMe_{b}Y_{c}Z₆, where a+mb+3c=6 and c>0 are satisfied. Me is at least one selected from the group consisting of metal elements other than Li and Y and metalloid elements. Z is at least one selected from the group consisting of F, Cl, Br, and I. The symbol m represents the valence of Me. The “metalloid elements” are B, Si, Ge, As, Sb, and Te. The “metal elements” are: all the elements included in Groups 1 to 12 of the periodic table (excluding hydrogen); and all the elements included in Groups 13 to 16 of the periodic table (excluding B, Si, Ge, As, Sb, Te, C, N, P, O, S, and Se).

In order to improve the ionic conductivity of the halide solid electrolyte, Me may be at least one selected from the group consisting of Mg, Ca, Sr, Ba, Zn, Sc, Al, Ga, Bi, Zr, Hf, Ti, Sn, Ta, and Nb.

The halide solid electrolyte may be LisYCl₆ or LisYBr₆.

The second solid electrolyte may be an organic polymer solid electrolyte.

An example of the organic polymer solid electrolyte is a compound of a polymer compound with a lithium salt.

The polymer compound may have an ethylene oxide structure. A polymer compound having an ethylene oxide structure can contain a large amount of a lithium salt, and accordingly can further increase the ionic conductivity.

Examples of the lithium salt include LiPF₆, LiBF₄, LiSbF₆, LiAsF₆, LiSO₃F₃, LiN(SO₂CF₃)₂, LiN(SO₂C₂F₅)₂, LiN(SO₂CF₃) (SO₂C₄F₉), and LiC(SO₂CF₃)₃. One lithium salt selected from these may be used alone. Alternatively, a mixture of two or more lithium salts selected from these may be used.

In order to facilitate transfer of lithium ions and thereby improve the output characteristics of the battery, at least one selected from the group consisting of the positive electrode 201, the electrolyte layer 202, and the negative electrode 203 may include a nonaqueous electrolyte solution, a gel electrolyte, or an ionic liquid.

The nonaqueous electrolyte solution contains a nonaqueous solvent and a lithium salt dissolved in the nonaqueous solvent.

Examples of the nonaqueous solvent include a cyclic carbonate solvent, a linear carbonate solvent, a cyclic ether solvent, a linear ether solvent, a cyclic ester solvent, a linear ester solvent, and a fluorinated solvent. Examples of the cyclic carbonate solvent include ethylene carbonate, propylene carbonate, and butylene carbonate. Examples of the linear carbonate solvent include dimethyl carbonate, ethyl methyl carbonate, and diethyl carbonate. Examples of the cyclic ether solvent include tetrahydrofuran, 1,4-dioxane, and 1,3-dioxolane. Examples of the linear ether solvent include 1,2-dimethoxyethane and 1,2-diethoxyethane. Examples of the cyclic ester solvent include γ-butyrolactone. Examples of the linear ester solvent include methyl acetate. Examples of the fluorinated solvent include fluoroethylene carbonate, methyl fluoropropionate, fluorobenzene, fluoroethyl methyl carbonate, and fluorodimethylene carbonate. One nonaqueous solvent selected from these may be used alone. Alternatively, a combination of two or more nonaqueous solvents selected from these may be used.

Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃) (SO₂C₄F₉), and LiC(SO₂CF₃)₃. One lithium salt selected from these may be used alone. Alternatively, a mixture of two or more lithium salts selected from these may be used. The concentration of the lithium salt falls, for example, within a range from 0.5 mol/L to 2 mol/L.

As the gel electrolyte, a polymer material impregnated with a nonaqueous electrolyte solution can be used. Examples of the polymer material include polyethylene oxide, polyacrylonitrile, polyvinylidene fluoride, polymethyl methacrylate, and a polymer having an ethylene oxide bond.

Examples of cations contained in the ionic liquid include:
(i) aliphatic linear quaternary salts such as tetraalkylammoniums and tetraalkylphosphoniums;
(ii) aliphatic cyclic ammoniums such as pyrrolidiniums, morpholiniums, imidazoliniums, tetrahydropyrimidiniums, piperaziniums, and piperidiniums; and
(iii) nitrogen-containing heterocyclic aromatic cations such as pyridiniums and imidazoliums.

Examples of anions contained in the ionic liquid include PF₆″, BF₄, SbF₆″, AsF₆″, SO₃CF₃, N(SO₂CF₃)₂, N(SO₂C₂F₅)₂, N(SO₂CF₃)(SO₂C₄F₉)—, and C(SO₂CF₃)₃″.

The ionic liquid may contain a lithium salt.

In order to improve the adhesion between particles, at least one selected from the group consisting of the positive electrode 201, the electrolyte layer 202, and the negative electrode 203 may contain a binder.

Examples of the binder include polyvinylidene fluoride, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, and carboxymethylcellulose. A copolymer can also be used as the binder. Examples of such a binder include a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more materials selected from these may be used as the binder.

At least one of the positive electrode 201 and the negative electrode 203 may contain a conductive additive in order to improve electronic conductivity.

Examples of the conductive additive include:
(i) graphites such as a natural graphite and an artificial graphite;
(ii) carbon blacks such as acetylene black and ketjen black;
(iii) conductive fibers such as a carbon fiber and metal fiber;
(iv) fluorinated carbon;
(v) metal powders such as an aluminum powder;
(vi) conductive whiskers such as a zinc oxide whisker and a potassium titanate whisker;
(vii) a conductive metal oxide such as titanium oxide; and
(viii) a conductive polymer compound such as polyaniline compound, polypyrrole compound, and polythiophene compound. To reduce the cost, the conductive additive in (i) or (ii) above may be used.

Instead of the electrolyte layer, a separator impregnated with an electrolyte solution may be used, or a casing in which a positive electrode, a separator portion, and a negative electrode are housed may be filled with an electrolyte solution. The electrolyte solution may be, for example, the nonaqueous electrolyte solution described above. Examples of the shape of the battery according to the fourth embodiment include a coin type, a cylindrical type, a prismatic type, a sheet type, a button type, a flat type, and a stack type.

The battery according to the fourth embodiment may be manufactured, for example, by preparing a material for forming a positive electrode, a material for forming an electrolyte layer, and a material for forming a negative electrode, and producing by a known method a stack in which the positive electrode, the electrolyte layer, and the negative electrode are disposed in this order.

### Other Embodiments

### (Additional Notes)

The following techniques are disclosed by the description of the above embodiments.

### (Technique 1)

A production method for a solid electrolyte, including

(A) performing fluorination treatment on a raw material including a composite oxide containing Li and Ti, to obtain a solid electrolyte including a crystal phase represented by the following composition formula (1),

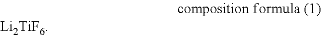

A titanium fluoride (TiF₄) is a relatively unstable substance that easily evaporate and also has deliquescence properties, etc. Furthermore, the titanium fluoride is a very expensive substance. In the production method of Technique 1, the composite oxide containing Li and Ti can be used as a Ti source. Therefore, with the production method of Technique 1, a solid electrolyte including a crystal phase represented by the composition formula (1): Li₂TiF₆ can be synthesized stably with good reproducibility without using the above unstable and expensive titanium fluoride as a raw material. Moreover, with the production method of Technique 1, a dry room in which the dew point is controlled is unnecessary. Thus, with the production method of Technique 1, for example, a solid electrolyte in which compositional variations (i.e., compositional deviation), alterations (e.g., incorporation of moisture, etc.), and generation of a secondary phase are suppressed and which has excellent characteristics such as ionic conductivity, can be produced stably with good reproducibility at a low cost. Moreover, with the production method of Technique 1, the fluoride is generated at a lower temperature as compared to a conventional production method, so that the raw material and the produced solid electrolyte are less likely to be exposed to high temperatures. Accordingly, the produced solid electrolyte does not become sintered and hard, and the particle growth of the solid electrolyte does not excessively proceed, so that a solid electrolyte that is soft and has excellent deformability is obtained as fine particles. When such a solid electrolyte having excellent deformability as fine particles is made into a compacted powder, an interface where particles are in close contact with each other is easily formed. To explain in more detail, the contact between particles that are difficult to deform becomes a point contact, while the contact between particles that are easy to deform forms a surface (joint interface) since the contact point between the particles spreads. Accordingly, voids are reduced and densification is achieved. Therefore, the solid electrolyte having the above configuration can be highly densified and is easily thinned, and further improvement of the ionic conductivity thereof can also be expected. Thus, for example, a useful solid electrolyte that, when used, for example, for a solid electrolyte layer of a battery, can achieve thinning of the solid electrolyte layer or can be suitably used for a coating layer for active material particles, is obtained. Therefore, with the solid electrolyte produced by the production method of Technique 1, a battery having high performance is realized.

### (Technique 2)

The production method for a solid electrolyte according to Technique 1, wherein the composite oxide is represented by the following composition formula (2), composition formula (2): LiₓTi_{y}O_{z}, and in the composition formula (2),

$$1.95 \leq x \leq 2.05 ,$$

$$0.95 \leq y \leq 1.05 , and$$

$$2.95 \leq z \leq 3.05$$

are satisfied.

In the production method of Technique 2, for example, an oxide that is stable in an atmospheric environment can be used as the composite oxide containing Li and Ti. Therefore, a solid electrolyte having good characteristics can be synthesized stably in the atmospheric environment with good reproducibility.

### (Technique 3)

The production method for a solid electrolyte according to Technique 2, wherein the composite oxide is Li₂TiO₃.

In the production method of Technique 3, for example, Li₂TiO₃, which is stable in an atmospheric environment, can be used as the composite oxide containing Li and Ti. In addition, a crystal phase represented by the composition formula (1): Li₂TiF₆ can be produced with good reproducibility and high quality by fluorination treatment of Li₂TiO₃.

Therefore, with the production method of Technique 3, a solid electrolyte having good characteristics can be synthesized stably in the atmospheric environment with good reproducibility.

### (Technique 4)

The production method for a solid electrolyte according to any one of Techniques 1 to 3, wherein
the (A) includes synthesizing the composite oxide using at least one selected from the group consisting of an oxide of Li, a carbonate of Li, and a hydroxide of Li and at least one selected from the group consisting of an oxide of Ti, a carbonate of Ti, and a hydroxide of Ti.

In the production method of Technique 4, a composite oxide (i.e., the composite oxide containing Li and Ti) can be synthesized as the raw material using a Li source and a Ti source which have higher stability in atmospheric air and against moisture and lower cost compared with LiF and TiF₄. By performing fluorination treatment on the composite oxide thus synthesized, a crystal phase represented by the composition formula (1): Li₂TiF₆ can be produced with good reproducibility and high quality. Moreover, with the production method of Technique 4, for example, high-quality Li₂TiOs controlled to be a single phase can also be obtained with good reproducibility. Therefore, with the production method of Technique 4, a solid electrolyte having good characteristics can be synthesized stably in the atmospheric environment with good reproducibility.

### (Technique 5)

The production method for a solid electrolyte according to any one of Techniques 1 to 4, wherein
the composite oxide is in particle form, and
a BET specific surface area of the composite oxide is 1.0 m²/g or more and 30 m²/g or less.

The composite oxide having the above configuration is suitable for fluorination treatment. Therefore, with the production method of Technique 5, a solid electrolyte including a crystal phase represented by the composition formula (1): Li₂TiF₆ can be synthesized in large quantities at a low cost.

### (Technique 6)

The production method for a solid electrolyte according to any one of Techniques 1 to 5, wherein
the raw material is substantially free of TiO₂.

In the production method of Technique 6, for example, in the process of converting the raw material into a fluoride, titanium tetrafluoride (TiF₄), which easily evaporates and has deliquescence properties, is less likely to be generated. Therefore, compositional variations and alterations of the produced solid electrolyte are suppressed, so that a solid electrolyte having high ionic conductivity can be stably produced. (Technique 7)

The production method for a solid electrolyte according to any one of Techniques 1 to 6, wherein
in the (A), the fluorination treatment on the raw material is performed by performing heat treatment on a fluorine-containing substance having thermal decomposition properties.

With the production method of Technique 7, fluorination of the raw material including the composite oxide containing Li and Ti and a solid-phase reaction can be caused to occur simultaneously, and a solid electrolyte including a crystal phase represented by the composition formula (1): Li₂TiF₆ can be synthesized. Therefore, a homogeneous solid electrolyte having excellent characteristics can be obtained in a short time while reducing reaction residues such as oxides. In addition, since the fluorination treatment is performed by performing heat treatment on the fluorine-containing substance having thermal decomposition properties, the reactivity (fluorination properties) of the composite oxide included in the raw material is good, and the productivity is also excellent. Furthermore, the temperatures of the fluorination reaction and the solid-phase reaction of the raw material and the reaction rates of these reactions can be controlled by selection of fluorine-containing substances having different thermal decomposition temperatures, adjustment of the particle diameter of the raw material, etc. Thus, fluorination treatment suitable for various raw materials can be performed.

### (Technique 8)

The production method for a solid electrolyte according to Technique 7, wherein
a temperature of the heat treatment is 200° C. or higher and 600° C. or lower.

In a conventional production method in which a fluoride (e.g., LiF and TiF₄) is used as a starting raw material and a solid electrolyte material is synthesized by a solid-phase reaction, heat treatment at a high temperature (e.g., 600° C. or higher and 800° C. or lower) is required. In contrast, with the production method of Technique 8, a solid electrolyte including a crystal phase represented by the composition formula (1): Li₂TiF₆ can be synthesized at a lower temperature than with the conventional production method. In addition, in the production method of Technique 8, the solid electrolyte to be produced can be inhibited from being sintered and becoming hard, or the particle growth of the solid electrolyte can be further inhibited from excessively proceeding. Therefore, a solid electrolyte that is softer, has more excellent deformability, and is in fine particle form, is obtained. Accordingly, the solid electrolyte obtained by the production method of Technique 8 more easily achieves densification and thinning of a compacted powder thereof. For example, when the solid electrolyte obtained by the production method of Technique 8 is used for a solid electrolyte layer of a battery, further thinning and higher ionic conductivity of the solid electrolyte layer can be achieved, or the solid electrolyte can be suitably used for a coating layer for active material particles to achieve higher ionic conductivity of an electrode. Therefore, with the solid electrolyte produced by the production method of Technique 8, a battery having higher performance is realized. (Technique 9)

The production method for a solid electrolyte according to Technique 7 or 8, wherein the fluorine-containing substance is in particle form.

With the production method of Technique 9, the fluorine-containing substance easily becomes thermally decomposed, and the contact area between the raw material and the fluorine-containing substance is increased. Thus, with the production method of Technique 9, the raw material can be efficiently fluorinated, and the fluorine-containing substance is less likely to remain in the finally obtained solid electrolyte. In addition, the fluorination reaction can be controlled by the particle shape of the fluorine-containing substance. For example, by making the particles of the fluorine-containing substance smaller, the temperature of the fluorination can be decreased, or the rate of the fluorination can be increased. In addition, by mixing the raw material and the fluorine-containing substance, uniform fluorination of the entire powder is enabled. Moreover, precise control of the fluorine amount is enabled. Thus, the synthesis of the desired solid electrolyte is enabled. In addition, the fluorine-containing substance can be used in an amount required for the fluorination of the raw material, so that, unlike the case where fluorine gas is introduced and used in a furnace, excess fluorine gas emission can be suppressed. Therefore, the environmental impact is reduced and the influence on corrosion of a furnace material, etc., is also reduced.

### (Technique 10)

The production method for a solid electrolyte according to any one of Techniques 7 to 9, wherein
the (A) includes
   (A-1) mixing the raw material and the fluorine-containing substance, and
   (A-2) fluorinating the raw material by performing heat treatment on a mixture including the raw material and the fluorine-containing substance obtained in the (A-1), to obtain the solid electrolyte.

In the production method of Technique 10, the heat treatment for the fluorination treatment can be performed on a homogeneous mixture obtained by mixing the raw material and the fluorine-containing substance. In addition, the contact area between the raw material and the fluorine-containing substance can be increased. Therefore, in the production method of Technique 10, the fluorination of the raw material can be uniformly promoted. Thus, a homogeneous solid electrolyte having excellent characteristics can be obtained with high productivity.

### (Technique 11)

The production method for a solid electrolyte according to any one of Techniques 7 to 9, wherein
in the (A), fluorine gas is generated by performing heat treatment on the fluorine-containing substance, and the raw material is fluorinated by bringing the fluorine gas into contact with the raw material, to obtain the solid electrolyte.

In the production method of Technique 11, the raw material can be fluorinated by the generated fluorine gas without bringing the raw material into direct contact with the fluorine-containing substance. Therefore, even when a fluorine-containing substance containing an inorganic component in addition to a fluorine element is used, there is no need to consider inorganic residues being incorporated into the solid electrolyte to be produced. Therefore, the range of fluorine-containing substances that can be used can be expanded.

### (Technique 12)

The production method for a solid electrolyte according to any one of Techniques 7 to 11, wherein
the fluorine-containing substance includes ammonium fluoride.

The thermal decomposition of ammonium fluoride starts at a relatively low temperature (e.g., about 150° C.). Therefore, the ammonium salt is less likely to remain as an unnecessary inorganic component in the finally obtained solid electrolyte and can be thermally decomposed at a low temperature to fluorinate the raw material. Thus, in the production method of Technique 12, the fluorine-containing substance effectively acts on the fluorination of the raw material at a low temperature (e.g., about 150 to 200° C.). Accordingly, in the production method of Technique 12, the solid electrolyte to be produced can be inhibited from being sintered and becoming hard, or the particle growth of the solid electrolyte can be further inhibited from excessively proceeding. Therefore, a solid electrolyte that is softer, has more excellent deformability, and is in fine particle form, is obtained. Accordingly, the solid electrolyte obtained by the production method of Technique 12 easily achieves densification and thinning of a compacted powder thereof. For example, when the solid electrolyte obtained by the production method of Technique 12 is used for a solid electrolyte layer of a battery, further thinning and higher ionic conductivity of the solid electrolyte layer can be achieved, or the solid electrolyte can be suitably used for a coating layer for active material particles to achieve higher ionic conductivity of an electrode. Therefore, with the solid electrolyte produced by the production method of Technique 12, a battery having higher performance is realized. Unnecessary inorganic components derived from the fluorine-containing substance can be inhibited from remaining in the finally obtained solid electrolyte. Furthermore, the energy for synthesis is saved, and the heating and cooling times are reduced, so that the productivity is also improved. Moreover, since synthesis at a low temperature is possible, the durability of the furnace material is improved, and the running cost and replacement frequency of a synthetic member are also significantly reduced.

### (Technique 13)

The production method for a solid electrolyte according to any one of Techniques 7 to 12, wherein
the fluorine-containing substance includes a resin.

With the production method of Technique 13, the fluorine-containing substance can fluorinate the raw material while being thermally decomposed at a relatively high temperature (e.g., about 450° C. or higher and 600° C. or lower). Therefore, the production method of Technique 13 is suitable for the case where it is desired to carry out the fluorination of the raw material and the solid-phase reaction at a relatively high temperature (e.g., about 450° C. or higher and 600° C. or lower).

### (Technique 14)

The production method for a solid electrolyte according to Technique 13, wherein
the resin is a fluorine resin.

The fluorine resin such as PTFE and PVDF can fluorinate the raw material while being thermally decomposed at a relatively high temperature (e.g., about 400° C. or higher and 600° C. or lower). Therefore, the production method of Technique 14 is suitable for the case where it is desired to carry out the fluorination of the raw material and the solid-phase reaction at a relatively high temperature (e.g., about 400° C. or higher and 600° C. or lower).

### (Technique 15)

The production method for a solid electrolyte according to any one of Techniques 7 to 14, wherein
the fluorine-containing substance includes a substance from which inorganic components generated by thermal decomposition during the heat treatment in the (A), other than a fluorine element, are substantially not incorporated into the solid electrolyte.

For the fluorine-containing substance, it is required that while the fluorine element generated by thermal decomposition during the heat treatment in the above (A) is replacing the oxygen element of the raw material, the other components are not incorporated as inorganic residues into the finally obtained solid electrolyte including a crystal phase represented by the composition formula (1): Li₂TiF₆. By using, as the fluorine-containing substance, a substance from which the inorganic components generated by thermal decomposition during the heat treatment, other than the fluorine element, are substantially not incorporated into the finally obtained solid electrolyte, only the fluorine element replaces the oxygen of the oxide, and the incorporation of inorganic residues into the solid electrolyte can be suppressed. As a result, a high-purity solid electrolyte having a desired composition can be obtained. Examples of the fluorine-containing substance from which the inorganic components generated by thermal decomposition during the heat treatment, other than the fluorine element, are substantially not incorporated into the finally obtained solid electrolyte, include substances from which inorganic components generated by thermal decomposition during heat treatment, other than the fluorine element, are converted into gas and discharged.

### (Technique 16)

The production method for a solid electrolyte according to any one of Techniques 7 to 15, wherein
the fluorine-containing substance includes a plurality of types of fluorine-containing compounds.

In the production method of Technique 16, for example, both ammonium fluoride and the fluorine resin can be used as the fluorine-containing substance. Accordingly, the temperature range where the fluorine-containing substance acts as a fluorine source can be controlled to be wide. Thus, the conversion of the raw material into the fluoride and the solid-phase reaction temperature can be controlled over a wide range. Therefore, with the production method of Technique 16, it becomes easy to obtain the desired solid electrolyte.

### (Technique 17)

The production method for a solid electrolyte according to any one of Techniques 1 to 16, further including
(B) performing pulverization treatment on the solid electrolyte obtained in the (A), after the (A).

With the production method of Technique 17, a solid electrolyte can be obtained with powder characteristics (e.g., particle shape, particle size, etc.) suitable for the application. In addition, at least a part of the solid electrolyte can be amorphized, so that ionic conductivity can be improved and the softness of the particles of the solid electrolyte can be improved. By improving the softness of the particles of the solid electrolyte, the density of a compacted powder of the solid electrolyte can be improved. Therefore, with the solid electrolyte obtained by the production method according to Technique 17, a dense compacted powder having high ionic conductivity can be formed. (Technique 18)

A solid electrolyte including a crystal phase represented by the following composition formula (1), the solid electrolyte being substantially free of TiF₄,

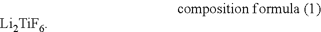

Owing to this configuration, a solid electrolyte having excellent ionic conductivity can be obtained. In addition, since the solid electrolyte according to Technique 18 is substantially free of TiF₄, temporal changes in characteristics, mechanical properties, etc., of the solid electrolyte caused by evaporation and deliquescence of TiF₄ can be suppressed. Therefore, a solid electrolyte having excellent characteristics and reliability can be realized. Even in the case where the raw material contains a trace amount of TiF₄, TiF₄ can be caused to evaporate and disappear by the heat treatment for the fluorination treatment. Therefore, a solid electrolyte that is substantially free of TiF₄ and has excellent characteristics and reliability can be obtained.

### (Technique 19)

A solid electrolyte including a crystal phase represented by the following composition formula (1) and further containing at least one selected from the group consisting of Zn, Mg, Nb, and P,

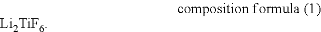

Owing to this configuration, a homogeneous solid electrolyte having excellent ionic conductivity is obtained.

### (Technique 20)

The solid electrolyte according to Technique 19, being substantially free of TiF₄.

Owing to this configuration, temporal changes in characteristics, mechanical properties, etc., of the solid electrolyte caused by evaporation and deliquescence of TiF₄ can be suppressed. Therefore, a solid electrolyte having excellent characteristics and reliability can be realized. Even in the case where the raw material contains a trace amount of TiF₄, TiF₄ can be caused to evaporate and disappear by the heat treatment for the fluorination treatment. Therefore, a solid electrolyte that is substantially free of TiF₄ and has excellent characteristics and reliability can be obtained.

### (Technique 21)

The solid electrolyte according to any one of Techniques 18 to 20, wherein the solid electrolyte is in particle form.

Owing to this configuration, a soft solid electrolyte with which an interface is easily formed is obtained. Therefore, a compacted powder of the solid electrolyte of Technique 21 has high ionic conductivity and excellent stability and can take any shape. In addition, the compacted powder of the solid electrolyte of Technique 21 has excellent deformability since the compacted powder can take any shape. Therefore, with the compacted powder of the solid electrolyte of Technique 21, a solid electrolyte layer of a battery or a coating layer for active material particles which has excellent characteristics and high reliability can be realized. As a result, with the solid electrolyte of Technique 21, a battery having high performance and high reliability is realized. The size and shape of the particles of the solid electrolyte can be selected as appropriate according to the application.

### (Technique 22)

The solid electrolyte according to any one of Techniques 18 to 21, wherein the crystal phase includes a first crystal phase belonging to a tetragonal crystal system.

Owing to this configuration, a solid electrolyte having high ionic conductivity can be obtained. In addition, the solid electrolyte can have heat resistance in the range of about 250° C. to 300° C., so that a battery having high reliability can be obtained.

### (Technique 23)

The solid electrolyte according to any one of Techniques 18 to 22, wherein
the solid electrolyte includes an amorphous phase.

Owing to this configuration, the amorphized part of the solid electrolyte becomes softer, has more excellent deformability, and has improved interparticle bonding. Therefore, with a compacted powder of the solid electrolyte, a solid electrolyte layer having higher ionic conductivity and higher stability can be formed in any shape. Thus, with the compacted powder of the solid electrolyte of Technique 23, a solid electrolyte layer of a battery or a coating layer for active material particles which has excellent characteristics and high reliability can be realized. As a result, with the solid electrolyte of Technique 23, a battery having high performance and high reliability is realized.

Although the production method for a solid electrolyte and the solid electrolyte according to the present disclosure have been described above based on the embodiments, the present disclosure is not limited to these embodiments. The embodiments including various modifications conceived of by a person skilled in the art, and other embodiments configured by combining some of components of the embodiments are also included in the scope of the present disclosure as long as the embodiments do not depart from the gist of the present disclosure.

In the above-described embodiments, various changes, replacements, additions, omissions, or the like can be made within the scope of the claims or the scope equivalent thereto.

### EXAMPLES

Hereinafter, the present disclosure will be described in more detail with reference to an example.

### <Synthesis of Solid Electrolyte>

### Example 1

First, Li₂TiO₃, which is a composite oxide used as a raw material, was synthesized. As starting raw materials for synthesizing Li₂TiO₃, Li₂O powder (average particle diameter: about 1.5 μm) and TiO₂ powder (average particle diameter: about 0.3 μm, rutile type) were prepared such that the composition ratio of Li₂TiOs was achieved. Furthermore, as additives, ZnO (average particle diameter: about 1.5 μm), MgO (average particle diameter: 2.2 μm), Nb₂O₅ (average particle diameter: about 1.6 μm), and P₂O₅ (average particle diameter: about 2.4 μm) were prepared. As for the additives, each powder was weighed such that ZnO was 0.02 mol %, MgO was 0.004 mol %, Nb₂O₅ was 0.15 mol %, and P₂O₅ was 0.03 mol %, with respect to Li₂TiOs to be synthesized. The weighing of these starting raw materials and additives was performed in an air atmosphere.

The powders of the starting raw materials and additives weighed as described above were mixed. 30 g of the obtained mixture powder, 600 g of q5 mm zirconia balls, and 200 mL of ethanol were placed in a ball mill having a capacity of 600 mL, and the mixture was mixed and pulverized for 20 h to prepare a slurry. The obtained slurry was dried at atmospheric pressure for 20 h using a hot air dryer at about 50 to 60° C. The dried powder was ground using a mortar and a pestle for about 10 minutes and then passed through a #32 mesh sieve to obtain a raw material powder including Li₂TiO₃. The average particle diameter of the obtained raw material powder was about 0.8 μm. The raw material powder also includes the above additives.

Subsequently, NH₄F powder (average particle diameter: about 120 μm), which is a fluorine-containing substance, was prepared and mixed with the raw material powder prepared by the above method. The NH₄F powder was added in an amount required for fluorination of the raw materials. Specifically, an amount of NH₄F that fluorinates all raw materials in the reaction formula was used.

The mixture of the raw material powder and the NH₄F powder was mixed with a pestle for about 10 minutes using an alumina mortar such that the mixture was uniform (step corresponding to the above (A-1)). Accordingly, a mixture including LizTiO3, which is a composite oxide, the above additives, and the fluorine-containing substance was obtained. The mixing of these materials was performed in normal atmospheric air as at the time of weighing.

Next, heat treatment was performed on the obtained mixture (step corresponding to the above (A-2)). As a sagger, a high-purity (SSA-H) alumina crucible (diameter q: 36 mm, height: 40 mm) was used, and about 3 g of the mixture was placed in the crucible. A spacer (thickness: 0.5 mm) was placed at the outer edge of the upper surface of the sagger in order to provide a gap such that reactive gas (mainly ammonia and CO₂) to be discharged during the heat treatment was allowed to easily escape, and an alumina plate-like lid was placed thereon to prevent foreign objects from falling. Next, the sagger having the lid placed as described above was placed at a center portion of a firing furnace, and heat treatment was performed. In the firing furnace, the sagger was placed on a support made of mullite and having a porosity of about 20% and a small heat capacity. A support having a length of 10 mm, a width of 10 mm, and a height of 10 mm was used, and three supports were placed under one sagger to float the sagger from the bottom of the furnace. Thus, heater (radiation) heat and an inert gas were allowed to circulate around to the bottom of the sagger. After the door of the furnace was closed and sealed, as the inert gas, nitrogen gas was caused to flow in at 2 L/min through an introduction port in the bottom of the furnace and was discharged through an exhaust port on the upper side of a ceiling, and the gas was continuously caused to flow until the heat treatment was completed. The temperature of the heat treatment was 700° C.

In this example, since the oxides were used as the starting raw materials, that is, no titanium fluoride was contained in the raw material, heat treatment could be performed in a manner similar to that of general oxide ceramics. For example, if heat treatment is performed on titanium fluoride without sealing as in this example, titanium fluoride will begin to evaporate around 50° C. to 100° C. and a large portion (about 70%) of titanium fluoride will disappear at 200° C. Therefore, a fluoride in normal solid-phase synthesis has large compositional variations. Therefore, using the Ti component as a composite oxide containing Ti is very effective for suppressing compositional variations from the viewpoint of evaporation and environmental stability.

On the solid electrolyte obtained by the above heat treatment, pulverization treatment was performed (step corresponding to the above (B)). In this example, dry pulverization treatment was performed. Specifically, zirconia balls (diameter: 15 mm) and the solid electrolyte obtained by the above heat treatment were placed in a ball mill (volume: 1 L) lined with zirconia, and the solid electrolyte was pulverized for 20 h.

### Comparative Example 1

Fluorides were used as raw materials, and a solid electrolyte of Comparative

Example 1 was produced by mechanochemical synthesis. Specifically, LiF and TiF₄ were prepared to have a molar ratio of LiF:TiF₄=2:1. In an Ar atmosphere (glove box), these materials were ground and mixed in a mortar for about 5 minutes. 10 g of the obtained mixture was placed in a planetary ball mill having a capacity of 500 mL together with 400 g of q5 mm zirconia balls, the planetary ball mill was sealed, and mechanochemical milling was performed at 500 rpm for 20 h. Thus, the solid electrolyte of Comparative Example 1 was synthesized.

### <Evaluation of Solid Electrolyte>

The crystal phase, the ionic conductivity, the electronic conductivity, the average particle diameter, and the BET specific surface area of the solid electrolyte of Example 1 synthesized as described above were evaluated. The crystal phase, the ionic conductivity, the average particle diameter, and the BET specific surface area were evaluated for both solid electrolytes after the heat treatment and before the pulverization treatment and after the pulverization treatment. In addition, the solid electrolyte of Comparative Example 1 was also evaluated for crystal phase. Moreover, analysis of trace components was also performed for the solid electrolyte of Example 1. (Crystal Phase)

The crystal phase was confirmed by powder X-ray diffraction measurement both after the heat treatment and before the pulverization treatment and after the pulverization treatment. An X-ray diffractometer (MiniFlex600, manufactured by Rigaku) was used for measurement. Cu-Kα rays (wavelengths: 1.5405 Å and 1.5444 Å) were used as X-ray sources.

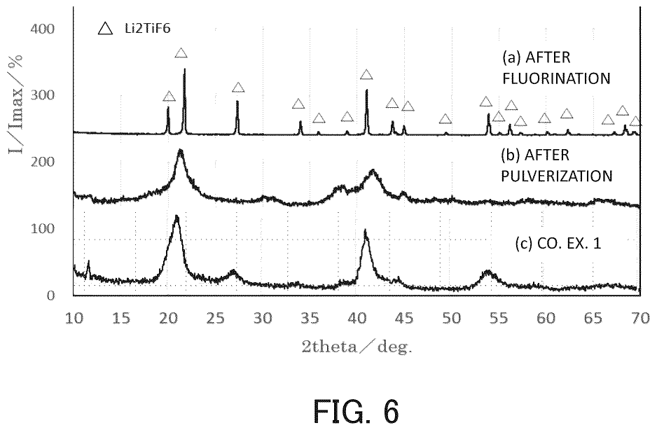

FIG. 6 is a graph showing an X-ray diffraction pattern of the solid electrolyte after the heat treatment (i.e., after fluorination) and before the pulverization treatment ((a) after fluorination) in the production method of Example 1, an X-ray diffraction pattern of the solid electrolyte after the pulverization treatment obtained in Example 1 ((b) after pulverization), and an X-ray diffraction pattern of the solid electrolyte obtained in Comparative Example 1 ((c) Comparative Example 1). As shown in FIG. 6, for the solid electrolyte after fluorination, an XRD pattern of a tetragonal Li₂TiF₆ single phase could be confirmed. For the solid electrolyte obtained by further pulverizing the solid electrolyte after fluorination, the state of progress of amorphization was confirmed from the X-ray diffraction pattern. For the solid electrolytes before and after pulverization, compared with the solid electrolyte before the pulverization treatment, the crystallinity was reduced by the pulverization treatment, but no undesired precipitate phase was observed. For the solid electrolyte obtained in Comparative Example 1, a peak was confirmed around a diffraction angle 2θ of 12° in the X-ray diffraction pattern, and, compared with the solid electrolyte of Example 1, compositional variations were confirmed. In addition, for the solid electrolyte of Comparative Example 1, it was also found that the solid electrolyte became hard due to progress of sintering, and thus amorphization, that is, broadening of the peaks in the X-ray diffraction pattern, did not proceed.

### (Ionic Conductivity)

For the ionic conductivity, a powder of the solid electrolyte was placed in a mold having a diameter of 10 mm, and a compacted powder sample was obtained by applying a pressure of about 3 t/cm using a single-axis hydraulic press. The ionic conductivity was calculated from the area, the thickness, and the impedance characteristics at room temperature of the compacted powder sample. The impedance measurement was performed at room temperature with pressure applied. The impedance measurement was performed at a measurement frequency of 10 Hz to 10 MHZ, a measurement voltage of 1 Vrms, and no DC bias. The deviation between the electrical lengths of a cable and a measurement jig was offset upon evaluation. For the solid electrolyte of Example 1, the ionic conductivity before the pulverization treatment was 0.87 μS/cm, and the ionic conductivity after the pulverization treatment was 1.6 μS/cm.

### (Electronic Conductivity)

The electronic conductivity was calculated from a DC voltage and current characteristics. The electronic conductivity of the solid electrolyte of Example 1 was <1.0×10⁻⁹ μS/cm and was a value that could be determined to have no electron-conducting properties.

### (Average Particle Diameter)

The average particle diameter is the value of a median diameter D50 obtained from a volume particle size distribution measured by a laser diffraction scattering particle size distribution measuring device. Specifically, a powder of the solid electrolyte was dispersed in an aqueous solution of 0.01 wt % sodium hexametaphosphate with a homogenizer, and then, the particle size distribution of the solid electrolyte was measured by a laser diffraction scattering particle size distribution measuring device (trade name: MT3100II, manufactured by MicrotracBEL Corp.) The value of D50 (i.e., cumulative 50% particle diameter) of the measured particle size distribution was regarded as the average particle size. For the solid electrolyte of Example 1, the average particle diameter before the pulverization treatment was 0.74 μm, and the average particle diameter after the pulverization treatment was 0.61 μm.

### (BET Specific Surface Area)

The BET specific surface area was determined by the BET multipoint method using a device for the nitrogen gas adsorption method. For the solid electrolyte of Example 1, the BET specific surface area before the pulverization treatment was 2.7 m²/g, and the BET specific surface area after the pulverization treatment was 3.6 m²/g.

### (Analysis of Trace Components)

The trace components contained in the solid electrolyte were analyzed by EPMA. Specifically, the trace components were analyzed as follows. A sample (powder) of the solid electrolyte was attached and fixed to a conductive tape (sample was adhered and fixed in a range of 5 mm×5 mm), and the composition (quantitative) was investigated through compositional analysis by point analysis. Although not confirmed by the X-ray diffraction measurement, it was confirmed that Zn, Mg, Nb, and P were contained in the solid electrolyte of Example 1. The content ratio of Zn was 0.02 at. %, the content ratio of Mg was 0.003 at. %, the content ratio of Nb was 0.2 at. %, and the content ratio of P was 0.06 at. %.

From the evaluation results of the solid electrolyte obtained in Example 1, according to the production method of the present disclosure, the oxide was successfully converted into a homogeneous fluoride, and as a result, a high ionic conductivity of 1.6 μS/cm was obtained. This ionic conductivity was at a level equal to or higher than that obtained from synthesis from fluoride raw materials, and with the production method of the present disclosure, a solid electrolyte having excellent characteristics was successfully obtained. The electronic conductivity was <1.0×10⁹ μS/cm, and it was confirmed that the solid electrolyte was an ionic conductive solid electrolyte having no electron-conducting properties (i.e., having a negligible level of electronic conductivity).

From the X-ray diffraction patterns shown in FIG. 6, according to the method of Example 1, a crystal phase represented by the composition formula (1): Li₂TiF₆ was confirmed. In addition, from these X-ray diffraction patterns, it was confirmed that the solid electrolyte obtained in Example 1 had a crystal quality similar to that of the solid electrolyte of Comparative Example 1 synthesized by the conventional method and compositional variations were suppressed compared with the solid electrolyte of Comparative Example 1. In addition, for the solid electrolyte of Example 1, in the X-ray diffraction pattern after the pulverization treatment, the peak changed to a broader peak than in the X-ray diffraction pattern before the pulverization treatment, and the progress of amorphization was confirmed. However, no new precipitate phase due to the pulverization treatment appeared. The changes in ionic conductivity, average particle diameter, and BET specific surface area before and after the pulverization treatment are as described in the explanation section for each evaluation item. From these results, it can be seen that the pulverization treatment may or may not necessarily be performed depending on the application of the solid electrolyte, etc., and the composition and the crystal phase of the solid electrolyte almost do not change regardless of the presence or absence of the pulverization treatment, so that excellent characteristics are maintained.

In addition, the amount of oxygen as an impurity in the solid electrolyte of Example 1 was 0.12 mass %, and it was confirmed that the oxygen in the oxide was converted to fluorine. For the amount of oxygen, gas (CO₂, CO) generated by melting a sample (powder) of the solid electrolyte using a melt extraction-type device was measured with a detector, and the amount of oxygen was evaluated based on the measurement results. The amount of oxygen in the solid electrolyte of Example 1 was rather smaller than that in a solid electrolyte obtained by a synthesis method using a fluoride as a starting raw material. The amount of oxygen in the solid electrolyte obtained by the synthesis method using a fluoride as a starting raw material is normally greater than 0.5 mass % and is about 1.0 mass % or less. The reason for this is considered to be that moisture, oxygen, etc., taken into unstable fluoride raw materials during storage or a synthesis process such as handling remain even after synthesis. If fluoride raw materials are mixed and subjected to a solid-phase reaction without the use of a sealed jig as in the production method of the present disclosure, the Ti component will evaporate as titanium fluoride and disappear from the fluoride due to the open atmosphere. Therefore, only a solid electrolyte with an ionic conductivity smaller than that of Example 1 is obtained due to variations in composition. In this case, the heat treatment temperature for synthesis also needs to be a high temperature of about 600° C.

As described above, with the production method of the present disclosure, a solid electrolyte including a crystal phase represented by the composition formula (1): Li₂TiF₆ can be produced as a solid electrolyte that has less compositional variations, etc., has high ionic conductivity similar to that with a conventional production method, is soft, and has excellent deformability, by a normal synthesis process (i.e., without sealing, etc., and in a synthetic environment in atmospheric air). In addition, whereas the cost of fluoride raw materials is very high, inexpensive oxide raw materials are used in the production method of the present disclosure, so that the production cost of the solid electrolyte can be reduced. Therefore, the production method of the present disclosure possesses significant industrial applicability.

### INDUSTRIAL APPLICABILITY

The production method for a solid electrolyte according to the present disclosure can be used, for example, as a production method for a solid electrolyte for secondary batteries such as all-solid-state batteries for use in various electronic devices or automobiles.

What is claimed is:

1. A production method for a solid electrolyte, comprising
(A) performing fluorination treatment on a raw material including a composite oxide containing Li and Ti, to obtain a solid electrolyte including a crystal phase represented by the following composition formula (1),

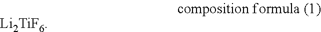

2. The production method for a solid electrolyte according to claim 1, wherein
the composite oxide is represented by the following composition formula (2),
composition formula (2): LiₓTi_{y}O_{z}, and
in the composition formula (2),
$$1.95 \leq x \leq 2.05 ,$$
$$0.95 \leq y \leq 1.05 , and$$
$$2.95 \leq z \leq 3.05$$
are satisfied.

3. The production method for a solid electrolyte according to claim 2, wherein the composite oxide is Li₂TiO₃.

4. The production method for a solid electrolyte according to claim 1, wherein
the (A) includes synthesizing the composite oxide using at least one selected from the group consisting of an oxide of Li, a carbonate of Li, and a hydroxide of Li and at least one selected from the group consisting of an oxide of Ti, a carbonate of Ti, and a hydroxide of Ti.

5. The production method for a solid electrolyte according to claim 1, wherein
the composite oxide is in particle form, and
a BET specific surface area of the composite oxide is 1.0 m²/g or more and 30 m²/g or less.

6. The production method for a solid electrolyte according to claim 1, wherein
the raw material is substantially free of TiO₂.

7. The production method for a solid electrolyte according to claim 1, wherein
in the (A), the fluorination treatment on the raw material is performed by performing heat treatment on a fluorine-containing substance having thermal decomposition properties.

8. The production method for a solid electrolyte according to claim 7, wherein the (A) includes
(A-1) mixing the raw material and the fluorine-containing substance, and
(A-2) fluorinating the raw material by performing heat treatment on a mixture including the raw material and the fluorine-containing substance obtained in the (A-1), to obtain the solid electrolyte.

9. The production method for a solid electrolyte according to claim 7, wherein
in the (A), fluorine gas is generated by performing heat treatment on the fluorine-containing substance, and the raw material is fluorinated by bringing the fluorine gas into contact with the raw material, to obtain the solid electrolyte.

10. The production method for a solid electrolyte according to claim 7, wherein
the fluorine-containing substance includes a resin.

11. The production method for a solid electrolyte according to claim 1, further comprising
(B) performing pulverization treatment on the solid electrolyte obtained in the (A), after the (A).

12. A solid electrolyte comprising a crystal phase represented by the following composition formula (1), the solid electrolyte being substantially free of TiF₄,

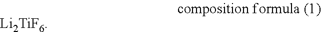

13. A solid electrolyte comprising a crystal phase represented by the following composition formula (1) and further comprising at least one selected from the group consisting of Zn, Mg, Nb, and P,

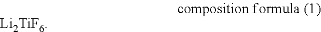

14. The solid electrolyte according to claim 13, being substantially free of TiF₄.

15. The solid electrolyte according to claim 13, wherein
the solid electrolyte is in particle form.

16. The solid electrolyte according to claim 13, wherein
the crystal phase includes a first crystal phase belonging to a tetragonal crystal system.

17. The solid electrolyte according to claim 13, wherein
the solid electrolyte comprises an amorphous phase.

18. A positive electrode material comprising the solid electrolyte according to claim 13.

19. A battery comprising a positive electrode including the positive electrode material according to claim 18.

20. A battery comprising:
a positive electrode;
a negative electrode; and
an electrolyte layer provided between the positive electrode and the negative electrode, wherein
at least one selected from the group consisting of the positive electrode, the negative electrode, and the electrolyte layer includes the solid electrolyte according to claim 13.
